(19) United States
(12) Patent Application Publication
(10) Pub. No.: US 2026/0219616 A1
(43) Pub. Date: Jul. 30, 2026

(54) IMAGE FORMING APPARATUS AND IMAGE FORMING METHOD

(71) Applicant: FUJIFILM Business Innovation Corp., Tokyo (JP)

(72) Inventors: Tomotake INAGAKI, Kanagawa (JP); Hitoshi KOMURO, Kanagawa (JP); Takashi OHASHI, Kanagawa (JP); Eiji KAWAKAMI, Kanagawa (JP)

(73) Assignee: FUJIFILM Business Innovation Corp., Tokyo (JP)

(21) Appl. No.: 19/428,365

(22) Filed: Dec. 22, 2025

(30) Foreign Application Priority Data
Jan. 24, 2025 (JP) 2025-010975

(51) Int. Cl. G03G 15/20

(52) U.S. Cl. CPC G03G 15/2057; G03G 15/206; G03G 15/2064; G03G 2215/2048

(57) ABSTRACT

An image forming apparatus includes: an image holder; a charging unit that charges a surface of the image holder; an electrostatic image forming unit that forms an electrostatic image on the charged surface of the image holder; a developing unit that accommodates an electrostatic image developer containing a toner in which a number proportion of toner particles having a particle diameter of 4 μm or less is 15% by number or more, and that develops the electrostatic image formed on the surface of the image holder into a toner image with the electrostatic image developer; a transfer unit that transfers the toner image onto a recording medium; and a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at arbitrary 50 points by an ultramicrohardness test specified in JIS Z2255 (2003), is 0% or more and 50% or less, and that fixes the toner image onto the recording medium by bringing the surface layer of the fixing member into contact with the toner image on the recording medium and heating and pressurizing the recording medium.

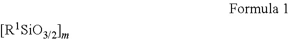

(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group, a plurality of R¹'s may be the same or different from each other, R² represents a hydrogen atom, a methyl group, or an ethyl group, in a case of a plurality of R²'s, the plurality of R²'s may be the same or different from each other, the monovalent organic group may be substituted with a halogen atom, a hydroxy group, an alkoxy group, an aryloxy group, an aralkyloxy group, or an oxy group, the alkyl group, the alkenyl group, the alkynyl group, the aralkyl group, and the aryl group may have a substituent, and m represents a positive integer)

### CROSS-REFERENCE TO RELATED APPLICATIONS

This application is based on and claims priority under 35 USC 119 from Japanese Patent Application No. 2025-010975 filed Jan. 24, 2025.

### BACKGROUND

### (i) Technical Field

The present disclosure relates to an image forming apparatus and an image forming method.

### (ii) Related Art

In an electrophotographic image forming apparatus, an image is formed by bringing a fixing member into contact with a toner image transferred onto a recording medium and heating and pressurizing the toner image to fix the toner image on the recording medium.

For example, JP1986-158362A discloses a heating fixing roll including at least a surface layer formed of a silicone rubber that is obtained by curing a polyorganosiloxane composition consisting basically of (A) a polyorganosiloxane, (B) a curing agent, and (C) a polymethylsilsesquioxane.

### SUMMARY

Aspects of non-limiting embodiments of the present disclosure relate to an image forming apparatus and an image forming method that have excellent fixing properties of a toner image in a recessed portion of a recording medium even in a case of forming an image on a recording medium having roughness using an electrostatic image developer that contains a toner in which a number proportion of toner particles having a particle diameter of 4 μm or less is 15% by number or more, as compared to an image forming apparatus including a fixing member having a surface layer that is a cured product of a composition in which a contained ratio (T type/D type) is less than 1/9 or more than 9/1, or having a surface layer in which a difference ΔH between the maximum value and the minimum value of an ultramicrohardness is more than 50%.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Methods for achieving the above-described object include the following aspects.

According to an aspect of the present disclosure, there is provided an image forming apparatus including:
an image holder;
a charging unit that charges a surface of the image holder;
an electrostatic image forming unit that forms an electrostatic image on the charged surface of the image holder;
a developing unit that accommodates an electrostatic image developer containing a toner in which a number proportion of toner particles having a particle diameter of 4 μm or less is 15% by number or more, and that develops the electrostatic image formed on the surface of the image holder into a toner image with the electrostatic image developer;
a transfer unit that transfers the toner image onto a recording medium; and
a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at arbitrary 50 points by an ultramicrohardness test specified in JIS Z2255 (2003), is 0% or more and 50% or less, and that fixes the toner image onto the recording medium by bringing the surface layer of the fixing member into contact with the toner image on the recording medium and heating and pressurizing the recording medium,

[R¹SiO_{3/2}]ₘ Formula 1
(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).

### BRIEF DESCRIPTION OF THE DRAWINGS

Exemplary embodiment(s) of the present invention will be described in detail based on the following figures, wherein:

FIG. 1 is a schematic cross-sectional view showing an example of a fixing member used in the present exemplary embodiment;

FIG. 2 is a view schematically showing a configuration of an example of a first exemplary embodiment of a fixing device used in the present exemplary embodiment;

FIG. 3 is a view schematically showing a configuration of an example of a second exemplary embodiment of a fixing device used in the present exemplary embodiment;

FIG. 4 is a view schematically showing a configuration of an example of a third exemplary embodiment of a fixing device used in the present exemplary embodiment; and

FIG. 5 is a view schematically showing a configuration of an example of an image forming apparatus according to the present exemplary embodiment.

### DETAILED DESCRIPTION

Exemplary embodiments of the present disclosure will be described. The following descriptions and examples merely illustrate the exemplary embodiments, and do not limit the scope of the invention.

In the present specification, a numerical range described using “to” represents a range including numerical values listed before and after “to” as a lower limit value and an upper limit value respectively, in a case where the numerical values are not described as “more than” and “less than”. In addition, a numerical range in a case where the numerical values before and after “to” are described as “more than” or “less than” means a range excluding the numerical values as the lower limit value or the upper limit value.

In numerical ranges described stepwise in the present specification, an upper limit value of a certain numerical range may be replaced with an upper limit value of another numerical range described stepwise, and may be replaced with a value shown in Examples. In addition, a lower limit value of a certain numerical range may be replaced with a lower limit value of another numerical range described stepwise, and may be replaced with a value shown in Examples.

In addition, “%” of a content means “% by mass” unless otherwise specified.
“0 to” as the content (%) means that the component is an optional component and may not be contained.

Each component may include a plurality of kinds of corresponding substances.

In a case where the amount of each component in a composition is mentioned, and there are two or more kinds of substances corresponding to each component in the composition, unless otherwise specified, the amount of each component means the total amount of two or more kinds of the substances present in the composition.

“Step” includes not only an independent step but a step which is not clearly distinguished from other steps as long as the intended action of the step is achieved.

### Image Forming Apparatus

The image forming apparatus according to the exemplary embodiment of the present disclosure includes an image holder, a charging unit that charges a surface of the image holder, an electrostatic image forming unit that forms an electrostatic image on the charged surface of the image holder, a developing unit that accommodates an electrostatic image developer and develops the electrostatic image formed on the surface of the image holder into a toner image with the electrostatic image developer, a transfer unit that transfers the toner image onto a recording medium, and a fixing device that fixes the toner image on the recording medium by bringing a surface layer of a fixing member into contact with the toner image on the recording medium and heating and pressurizing the toner image.

The electrostatic image developer contains a toner in which a number proportion of toner particles having a particle diameter of 4 μm or less is 15% by number or more.

In addition, the surface layer of the fixing member contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less. In the surface layer, a difference ΔH between the maximum value and the minimum value of an ultramicrohardness that is measured at arbitrary 50 points by an ultramicrohardness test specified in JIS Z2255 (2003) is 0% or more and 50% or less.

The contained ratio (T type/D type) represents a mass ratio.

In the related art, a toner containing a large amount of fine toner particles (specifically, toner particles having a particle diameter of 4 μm or less) has been used, and for example, a small-diameter toner is required to improve image quality of a toner image, or the like, and thus contains a large amount of the fine toner particles. In the fine toner particles, a proportion of an intercalation substance such as an external additive is relatively large, and thus the fine toner particles have deteriorated heat transfer properties. In addition, in a recording medium having roughness, such as embossed paper (examples thereof include REZAKKU 66 (manufactured by Tokai Special Paper Co., Ltd., difference in roughness of a surface: 80 μm, 151 g/m²)), there is a region where the fixing member does not come into contact with a recessed portion of the roughness, and thus fixing properties of the toner are deteriorated at the portion. Therefore, in a case where an image is formed on the recording medium having roughness, such as embossed paper, with a toner containing a large amount of fine toner particles, it is required to improve the fixing properties of the fine toner particles in a recessed portion of the recording medium.

On the other hand, in the image forming apparatus according to the present exemplary embodiment, the surface layer of the fixing member is formed from a cured product of a composition containing the organopolysiloxane (T type) having a silsesquioxane structure and the dimethyl organopolysiloxane (D type) at the above-described contained ratio. Therefore, in the above-described surface layer, the release properties with respect to the toner are ensured, and the flexibility of the surface layer is improved by containing the dimethyl organopolysiloxane (D type). That is, even in a case where the recording medium having roughness is used, the followability of the fixing member to the recessed portion is improved, and even in a case where the toner containing a large amount of fine toner particles is used, excellent fixing properties are obtained.

Hereinafter, the exemplary embodiment of the present disclosure will be described in more detail.

### Fixing Member

The fixing device includes a fixing member. The fixing member has at least the surface layer, and may further have a base material, and may have an elastic layer between the base material and the surface layer. The fixing member fixes the toner image on the recording medium by bringing the surface layer into contact with the toner image on the recording medium and heating and pressurizing the toner image. A shape of the fixing member may be, for example, a belt shape.

### Surface Layer

The surface layer of the fixing member does not contain a fluorine atom. The fact that the surface layer does not contain a fluorine atom means that a compound containing a fluorine atom (F) in a molecular structure is not contained. Examples of the compound containing a fluorine atom (F) in the molecular structure include fluororesins such as a tetrafluoroethylene/perfluoroalkyl vinyl ether copolymer (PFA), polytetrafluoroethylene (PTFE), a tetrafluoroethylene/hexafluoropropylene copolymer (FEP), polyethylene/tetrafluoroethylene (ETFE), polyvinylidene fluoride (PVDF), polychlorotrifluoroethylene (PCTFE), and polyvinyl fluoride (PVF).

The surface layer is a cured product of a composition (hereinafter, also referred to as “specific composition”) containing the organopolysiloxane (T type) having a silsesquioxane structure represented by Formula 1 and the dimethyl organopolysiloxane (D type). The contained ratio (T type/D type) of the organopolysiloxane (T type) to the dimethyl organopolysiloxane (D type) in the specific composition is 1/9 or more and 9/1 or less.

### Organopolysiloxane (T Type)

The organopolysiloxane (T type) having a silsesquioxane structure represented by Formula 1 will be described.

[R¹SiO_{3/2}]ₘ Formula 1
(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group, a plurality of R¹'s may be the same or different from each other,
R² represents a hydrogen atom, a methyl group, or an ethyl group, in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer)

The organopolysiloxane (T type) has only the silsesquioxane structure represented by Formula 1 (that is, the constitutional unit represented by “R¹SiO_{3/2}”) as a constitutional unit constituting a molecular structure.

R¹ is at least one selected from the group consisting of a hydrogen atom, an alkyl group, an alkenyl group, an alkynyl group, an aralkyl group, an aryl group, a group represented by —C(═O)—CR²₃, and a monovalent organic group having a reactive group (hereinafter, also referred to as “polymerizable functional group”). In a case where m is 2 or more, a plurality of R¹'s may be the same or different from each other.

R¹ may be an alkyl group. The alkyl group may be an aliphatic group or an alicyclic group, and may be linear or branched. The number of carbon atoms in the alkyl group is, for example, preferably 1 or more and 10 or less, more preferably 1 or more and 4 or less, still more preferably 1 or more and 2 or less, and particularly preferably 1, that is, a methyl group. Specific examples of the alkyl group having 1 or more and 10 or less carbon atoms include a methyl group, an ethyl group, a propyl group, a butyl group, a pentyl group, a hexyl group, a heptyl group, an octyl group, a nonyl group, and a decyl group.

R¹ may be an alkenyl group. The alkenyl group may be an aliphatic group, an alicyclic group, or an aromatic group, and may be linear or branched. The number of carbon atoms in the alkenyl group is, for example, preferably 1 or more and 10 or less. Specific examples of the alkenyl group having 1 or more and 10 or less carbon atoms include an ethenyl (vinyl) group, an ortho-styryl group, a meta-styryl group, a para-styryl group, a 1-propenyl group, a 2-propenyl (allyl) group, a 1-butenyl group, a 1-pentenyl group, a 3-methyl-1-butenyl group, a phenylethenyl group, an allyl(2-propenyl) group, and an octenyl (7-octen-1-yl) group.

R¹ may be an alkynyl group. The alkynyl group may be an aliphatic group, an alicyclic group, or an aromatic group, and may be linear or branched. The number of carbon atoms in the alkynyl group is, for example, preferably 1 or more and 10 or less. Specific examples of the alkynyl group include an ethynyl group, a 1-propynyl group, a 1-butynyl group, a 1-pentynyl group, a 3-methyl-1-butynyl group, and a phenylbutynyl group.

R¹ may be an aralkyl group. The number of carbon atoms in the aralkyl group is, for example, preferably 7 or more and 20 or less, and more preferably 7 or more and 10 or less. Examples of the aralkyl group having 7 or more and 20 or less carbon atoms include a phenylalkyl group such as a benzyl group.

R¹ may be an aryl group. The number of carbon atoms in the aryl group is, for example, preferably 6 or more and 20 or less, more preferably 6 or more and 10 or less, and still more preferably 6, that is, a phenyl group. Examples of the aryl group having 6 or more and 20 or less carbon atoms include a phenyl group, a 1-naphthyl group, and a 2-naphthyl group.

R¹ may be —C(═O)—CR²₃. R² represents a hydrogen atom, a methyl group, or an ethyl group. R² is, for example, preferably a methyl group. In a case of a plurality of R²'s, the plurality of R²'s may be the same or different from each other.

R¹ may be a monovalent organic group having a reactive group (polymerizable functional group). Examples of the polymerizable functional group include a polymerizable functional group that can be thermoset or photocured. The polymerizable functional group is not particularly limited, and examples thereof include a vinyl group, an allyl group, a styryl group, a methacryloyl group, an acryloyl group, an acryloyloxy group, a methacryloyloxy group, an α-methylstyryl group, a vinyl ether group, a vinyl ester group, an acrylamide group, a methacrylamide group, an N-vinyl amide group, a maleic acid ester group, a fumaric acid ester group, an N-substituted maleimide group, an isocyanate group, an oxetanyl group, and an epoxy group. Among these, as the polymerizable functional group, for example, a polymerizable functional group having a (meth)acryloyl group, an oxetanyl group, or an epoxy group is preferable. The polymerizable functional group may be further substituted with a halogen atom, a hydroxy group, an alkoxy group, an aryloxy group, an aralkyloxy group, or an oxy group.

As the polymerizable functional group having a (meth)acryloyl group, for example, a group represented by the following formula or a group including the group is preferable.

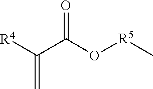

In the formula, R⁴ represents a hydrogen atom or a methyl group, and R⁵ represents an alkylene group having 1 or more and 10 or less carbon atoms. R⁴ is, for example, preferably an alkylene group having 2 or more and 10 or less carbon atoms.

The oxetanyl group is not particularly limited, and examples thereof include a (3-ethyl-3-oxetanyl) methoxy group and a (3-ethyl-3-oxetanyl)oxy group. As the polymerizable functional group having an oxetanyl group, for example, a group represented by the following formula or a group including the group is preferable.

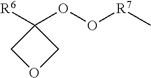

In the formula, R⁶ represents a hydrogen atom or an alkyl group having 1 or more and 6 or less carbon atoms, and R⁷ represents an alkylene group having 1 or more and 6 or less carbon atoms. R⁶ is, for example, preferably a hydrogen atom, a methyl group, an ethyl group, or the like, and more preferably an ethyl group. R⁷ is, for example, preferably an alkylene group having 2 or more and 6 or less carbon atoms, and more preferably a propylene group.

The polymerizable functional group having an epoxy group is not particularly limited, and examples thereof include an alkyl group having 1 or more and 10 or less carbon atoms, that is substituted with a glycidyloxy group, such as β-glycidyloxyethyl, γ-glycidyloxypropyl, and γ-glycidyloxybutyl; and an alkyl group having 5 or more and 10 or less carbon atoms, that is substituted with an oxirane group, such as a glycidyl group, a β-(3,4-epoxycyclohexyl)ethyl group, a γ-(3,4-epoxycyclohexyl) propyl group, a β-(3,4-epoxycycloheptyl)ethyl group, a 4-(3,4-epoxycyclohexyl)butyl group, and a 5-(3,4-epoxycyclohexyl) pentyl group.

The polymerizable functional group may be a functional group having a carbon-carbon double bond or a carbon-carbon triple bond, that can be hydrosilylated with a hydrogen atom (hydrosilyl group) bonded to a silicon atom. The unsaturated organic group can also function as the polymerizable functional group in a sense that the hydrogen atom in the hydrosilyl group polymerizes by a hydrosilylation reaction to form a hydrosilylated structural part. Specific examples of the unsaturated organic group include the above-described alkenyl group, alkynyl group, and the like. The unsaturated organic group is not particularly limited, and examples thereof include a vinyl group, an ortho-styryl group, a meta-styryl group, a para-styryl group, an acryloyl group, a methacryloyl group, an acryloxy group, a methacryloxy group, a 1-propenyl group, a 1-butenyl group, a 1-pentenyl group, a 3-methyl-1-butenyl group, a phenylethenyl group, an ethynyl group, a 1-propynyl group, a 1-butynyl group, a 1-pentynyl group, a 3-methyl-1-butynyl group, a phenylbutynyl group, an allyl(2-propenyl) group, and an octenyl (7-octen-1-yl) group. The unsaturated organic group is, for example, preferably a vinyl group, a para-styryl group, an allyl(2-propenyl) group, or an octenyl (7-octen-1-yl) group, and more preferably a vinyl group.

In the entire organopolysiloxane (T type) having a silsesquioxane structure represented by Formula 1, two or more kinds of polymerizable functional groups may be included. In this case, all the polymerizable functional groups may be the same or different from each other. In addition, the plurality of polymerizable functional groups may be the same and may further include different polymerizable functional groups.

The alkyl group, the alkenyl group, the alkynyl group, the aralkyl group, the aryl group, —C(═O)—CR²₃, and the polymerizable functional group, represented by R¹, may have a substituent. Examples of the substituent include at least one or more of a halogen atom such as a fluorine atom, a chlorine atom, a bromine atom, and an iodine atom; an alkyl group such as a methyl group, an ethyl group, a n-propyl group, an isopropyl group, a n-butyl group, a s-butyl group, an isobutyl group, a tert-butyl group, a n-pentyl group, a n-hexyl group, a n-heptyl group, a n-octyl group, and an isooctyl group; a hydroxy group; an alkoxy group; an aryloxy group; an aralkyloxy group; an oxy group (═O); a cyano group; a protected hydroxyl group; and the like.

A protecting group of the hydroxyl group in the protected hydroxyl group is not particularly limited, and a known hydroxyl group-protecting group is used. Examples of the protecting group include an acyl-based protecting group represented by —C(═O) R (in the formula, R represents an alkyl group having 1 or more and 6 or less carbon atoms, such as a methyl group, an ethyl group, a n-propyl group, an isopropyl group, a n-butyl group, an isobutyl group, a s-butyl group, a tert-butyl group, and an n-pentyl group, or a phenyl group having or not having a substituent; examples of the substituent of the phenyl group having a substituent include an alkyl group such as a methyl group, an ethyl group, a n-propyl group, an isopropyl group, a n-butyl group, a s-butyl group, an isobutyl group, a tert-butyl group, a n-pentyl group, a n-hexyl group, a n-heptyl group, a n-octyl group, and an isooctyl group, a halogen atom such as a fluorine atom, a chlorine atom, and a bromine atom, an alkoxy group such as a methoxy group and an ethoxy group, and the like); a silyl-based protecting group such as a trimethylsilyl group, a triethylsilyl group, a tert-butyldimethylsilyl group, and a tert-butyldiphenylsilyl group; an acetal-based protecting group such as a methoxymethyl group, a methoxyethoxymethyl group, a 1-ethoxyethyl group, a tetrahydropyran-2-yl group, and a tetrahydrofuran-2-yl group; an alkoxycarbonyl-based protecting group such as a t-butoxycarbonyl group; and an ether-based protecting group such as a methyl group, an ethyl group, a tert-butyl group, an octyl group, an allyl group, a triphenylmethyl group, a benzyl group, a p-methoxybenzyl group, a fluorenyl group, a trityl group, and a benzhydryl group.

In Formula 1, at least one of R¹'s is, for example, preferably a methyl group or a phenyl group, and more preferably a methyl group.

The number of silsesquioxane structures represented by Formula 1 in the organopolysiloxane (T type) (that is, the number of m's) is a positive integer.

### Dimethyl Organopolysiloxane (D Type)

The dimethyl organopolysiloxane (D type) has a structure represented by Formula 2.

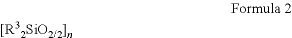

(in Formula 2, R³'s each independently represent a hydrogen atom, an alkyl group, an alkenyl group, an alkynyl group, an aralkyl group, an aryl group, a group represented by —C(═O)—CR²₃, or a monovalent organic group having a reactive group, a plurality of R³'s may be the same or different from each other,
R² represents a hydrogen atom, a methyl group, or an ethyl group, in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
n represents a positive integer)

The dimethyl organopolysiloxane (D type) has only the structure represented by Formula 2 (that is, the constitutional unit represented by “R³₂SiO_{2/2}”) as a constitutional unit constituting a molecular structure.

R³ is at least one selected from the group consisting of a hydrogen atom, an alkyl group, an alkenyl group, an alkynyl group, an aralkyl group, an aryl group, a group represented by —C(═O)—CR²₃, and a monovalent organic group having a reactive group (polymerizable functional group). In a case where n is 2 or more, a plurality of R³'s may be the same or different from each other.

Examples of the aspects of the alkyl group, the alkenyl group, the alkynyl group, the aralkyl group, the aryl group, —C(═O)—CR³₃, and the polymerizable functional group include the same configurations as the various aspects described for “R¹” of Formula 1.

The number of structures represented by Formula 2 in the dimethyl organopolysiloxane (D type) (that is, the number of n's) is a positive integer.

### Contained Ratio (T Type/D Type)

The contained ratio (T type/D type) of the organopolysiloxane (T type) to the dimethyl organopolysiloxane (D type) included in the specific composition is 1/9 or more and 9/1 or less. By setting the contained ratio (T type/D type) to be 1/9 or more, the release properties of the surface layer with respect to the toner are improved, and excellent fixing properties are obtained. By setting the contained ratio (T type/D type) to be 9/1 or less, the flexibility of the surface layer is improved, and the followability of the fixing member to the recessed portion of the recording medium having roughness is improved, so that excellent fixing properties are obtained even in a case when the toner containing a large amount of fine toner particles is used. From the viewpoint of further improving the fixing properties, the contained ratio (T type/D type) is, for example, preferably 3/7 or more and 7/3 or less.

A method of detecting the contained ratio of the organopolysiloxane (T type) and the dimethyl organopolysiloxane (D type) in the specific composition from the surface layer that is a cured product of the specific composition will be described. The contained ratio is calculated by measuring contents of the organopolysiloxane (T type) and the dimethyl organopolysiloxane (D type) by analyzing the surface layer with infrared absorption spectroscopy (IR).

### Surface Layer: Other Additives

The surface layer may contain other additives in addition to the organopolysiloxane (T type) and the dimethyl organopolysiloxane (D type). Examples of the other additives include conductive particles (for example, carbon black), low friction particles (for example, graphite), molybdenum disulfide, and silica particles. A content of each additive may be, for example, 1% by mass or more and 5% by mass or less for the conductive particles, 1% by mass or more and 10% by mass or less for the low friction particles, and 1% by mass or more and 20% by mass or less for the silica particles. In a case where the surface layer contains other additives, the total amount of the organopolysiloxane (T type) and the dimethyl organopolysiloxane (D type) in the surface layer is, for example, preferably 60% by mass or more, and more preferably 80% by mass or more. The total amount of the organopolysiloxane (T type) and the dimethyl organopolysiloxane (D type) in the surface layer may be 100% by mass (that is, the surface layer may not contain other additives).

Difference ΔH between Maximum Value and Minimum Value of Ultramicrohardness

In the surface layer, the difference ΔH between the maximum value and the minimum value of an ultramicrohardness that is measured at arbitrary 50 points by an ultramicrohardness test specified in JIS Z2255 (2003) is 0% or more and 50% or less. The difference ΔH being equal to or less than the above-described upper limit value means that the organopolysiloxane (T type) and the dimethyl organopolysiloxane (D type) are dispersed in the surface layer and that unevenness of the two is suppressed. Therefore, by setting the difference ΔH to be equal to or less than the above-described upper limit value, the surface layer has improved flexibility while ensuring the release properties with respect to the toner. As a result, even in a case where the recording medium having roughness is used, the followability of the fixing member to the recessed portion is improved, and even in a case where the toner containing a large amount of fine toner particles is used, excellent fixing properties are obtained. From the viewpoint of further improving the fixing properties, the above-described difference ΔH of the surface layer is, for example, preferably 0% or more and 40% or less.

From the viewpoint of controlling the difference ΔH between the maximum value and the minimum value of the ultramicrohardness within the above-described range, for example, it is preferable to use compounds in a solution state at normal temperature (that is, 25° C.) for both the organopolysiloxane (T type) and the dimethyl organopolysiloxane (D type). In addition, for example, it is preferable that the combination of the organopolysiloxane (T type) and the dimethyl organopolysiloxane (D type) is a combination of materials having high compatibility, so that the organopolysiloxane (T type) and the dimethyl organopolysiloxane (D type) are favorably dispersed in a case of being kneaded.

### Tensile Elongation Rate

For example, the surface layer preferably has a tensile elongation rate of 50% or more, and more preferably has a tensile elongation rate of 70% or more. The upper limit value of the tensile elongation rate of the surface layer is not particularly limited, but is, for example, preferably 300%. By setting the lower limit value of the tensile elongation rate to be within the above-described range, the surface layer has improved flexibility while maintaining strength, and excellent fixing properties are obtained.

A method of measuring the tensile elongation rate of the surface layer is as follows. The surface layer is cut into 80 mm×5 mm such that a circumferential direction is the long side, and a test is performed at a tensile speed of 20 mm/min with a test piece length between chucks of 40 mm using a tensile tester (MODEL-1605N, manufactured by Aiko Engineering Co., Ltd.) to calculate the tensile elongation rate.

In order to control the tensile elongation rate within the above-described range, for example, the surface layer preferably contains the organopolysiloxane (T type) and the dimethyl organopolysiloxane (D type) in a dispersed state, and unevenness of the two is suppressed. Therefore, for example, it is preferable to use compounds in a solution state at normal temperature (that is, 25° C.) for both the organopolysiloxane (T type) and the dimethyl organopolysiloxane (D type). In addition, for example, it is preferable that the combination of the organopolysiloxane (T type) and the dimethyl organopolysiloxane (D type) is a combination of materials having high compatibility, so that the organopolysiloxane (T type) and the dimethyl organopolysiloxane (D type) are favorably dispersed in a case of being kneaded.

### Surface Roughness of Surface Layer

A surface roughness Ra of an outer peripheral surface of the surface layer, that is, a surface on a side in contact with the toner image is, for example, preferably 1 μm or less, and more preferably 0.5 μm or less. By the surface roughness Ra being in the above-described range, fixing properties are improved.

The surface roughness Ra is obtained as follows. A measurement sample is cut out from the surface layer (or the fixing member having the surface layer). Ra is measured for the measurement sample using a stylus type surface roughness measuring machine (SURFCOM 1400A; manufactured by Tokyo Seimitsu Co., Ltd.). The measurement conditions are in accordance with JIS B 0601-1994, and the evaluation length Ln is set to 2.5 mm, the reference length L is set to 0.8 mm, and the cut-off value is set to 0.008 mm.

### Method of Forming Surface Layer

As a method of forming the surface layer, for example, first, a specific composition obtained by mixing a liquid organopolysiloxane (T type) and a liquid dimethyl organopolysiloxane (D type) is prepared. The obtained specific composition is dip-coated onto a cylindrical mold on which the base material of the fixing member is installed, and is cured to form the surface layer on the base material.

### Base Material and Elastic Layer

The fixing member includes at least the surface layer, and may further include a base material. Furthermore, the fixing member may include an elastic layer between the base material and the surface layer.

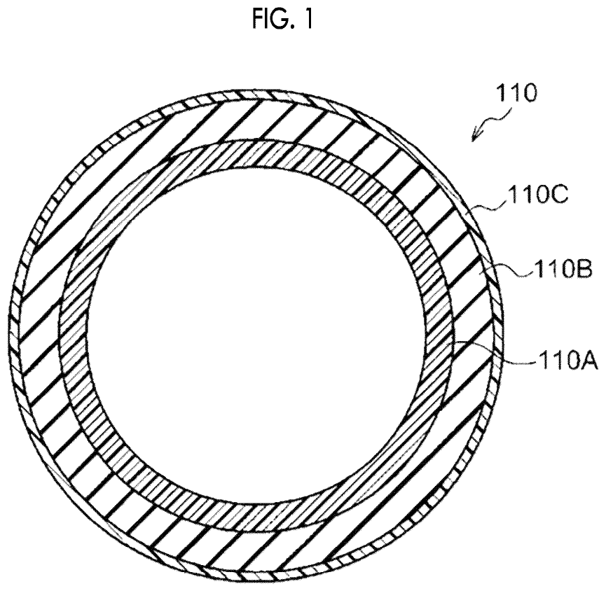

Hereinafter, the fixing member according to the present exemplary embodiment will be described with reference to FIG. 1.

FIG. 1 is a view schematically showing a configuration of an example of the fixing member according to the present exemplary embodiment.

A fixing member 110 shown in FIG. 1 includes a base material layer 110A, an elastic layer 110B provided on the base material layer 110A, and a surface layer 110C provided on the elastic layer 110B.

A layer configuration of the fixing member 110 according to the present exemplary embodiment is not limited to the layer configuration shown in FIG. 1, and the fixing member 110 may not include the elastic layer 110B or may not include the base material layer 110A. The fixing member 110 according to the present exemplary embodiment may have a layer configuration in which a metal layer and a protective layer for the metal layer are interposed between the base material layer 110A and the elastic layer 110B; a layer configuration in which an adhesive layer is interposed between the base material layer 110A and the elastic layer 110B; a layer configuration in which an adhesive layer is interposed between the elastic layer 110B and the surface layer 110C; or a layer configuration obtained by combining the layer configurations.

Hereinafter, constituent components of the fixing member according to the present exemplary embodiment will be described in detail. The reference numerals will not be provided.

### Base Material Layer

Examples of the base material layer include a resin layer containing a resin such as polyimide. In addition, the base material layer may contain an additive such as a filler in the resin.

Examples of the polyimide include an imidized polyamic acid (polyimide precursor) that is a polymer of a tetracarboxylic dianhydride and a diamine compound. Specific examples of the polyimide include a resin obtained by polymerizing equimolar amounts of a tetracarboxylic dianhydride and a diamine compound in a solvent to obtain a polyamic acid solution, and imidizing the polyamic acid.

Examples of the tetracarboxylic dianhydride include an aromatic tetracarboxylic dianhydride compound and an aliphatic tetracarboxylic dianhydride compound; and from the viewpoint of heat resistance, for example, an aromatic tetracarboxylic dianhydride compound is preferable.

Examples of the aromatic tetracarboxylic dianhydride include pyromellitic dianhydride, 3,3′,4,4′-benzophenone tetracarboxylic dianhydride, 3,3′,4,4′-biphenylsulfone tetracarboxylic dianhydride, 1,4,5,8-naphthalenetetracarboxylic dianhydride, 2,3,6,7-naphthalenetetracarboxylic dianhydride, 3,3′,4,4′-biphenyl ether tetracarboxylic dianhydride, 3,3′,4,4′-dimethyldiphenylsilane tetracarboxylic dianhydride, 3,3′,4,4′-tetraphenylsilane tetracarboxylic dianhydride, 1,2,3,4-furan tetracarboxylic dianhydride, 4,4′-bis(3,4-dianhydride, dicarboxyphenoxy)diphenylsulfide 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidene diphthalic dianhydride, 3,3′,4,4′-biphenyltetracarboxylic dianhydride, 2,3,3′,4′-biphenyltetracarboxylic dianhydride, bis(phthalic)phenylphosphine oxide dianhydride, p-phenylene-bis(triphenylphthalic) dianhydride, m-phenylene-bis(triphenylphthalic)dianhydride, bis(triphenylphthalic)-4,4′-diphenyl ether dianhydride, and bis(triphenylphthalic)-4,4′-diphenylmethane dianhydride.

Examples of the aliphatic tetracarboxylic dianhydride include aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic acid dianhydride, 3,5,6-tricarboxynorbornane-2-acetic acid dianhydride, 2,3,4,5-tetrahydrofuran tetracarboxylic dianhydride, 5-(2,5-dioxotetrahydrofuryl)-3-methyl-3-cyclohexene-1,2-dicarboxylic acid dianhydride, and bicyclo[2,2,2]-oct-7-ene-2,3,5,6-tetracarboxylic dianhydride; and aliphatic tetracarboxylic dianhydrides having an aromatic ring, such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Among these, as the tetracarboxylic dianhydride, for example, an aromatic tetracarboxylic dianhydride is preferable, and specifically, for example, pyromellitic dianhydride, 3,3′,4,4′-biphenyltetracarboxylic dianhydride, 2,3,3′,4′-biphenyltetracarboxylic dianhydride, 3,3′,4,4′-biphenyl ether tetracarboxylic dianhydride, or 3,3′,4,4′-benzophenonetetracarboxylic dianhydride is preferable; pyromellitic dianhydride, 3,3′,4,4′-biphenyltetracarboxylic dianhydride, or 3,3′,4,4′-benzophenonetetracarboxylic dianhydride is more preferable; and 3,3′,4,4′-biphenyltetracarboxylic dianhydride is particularly preferable.

The tetracarboxylic dianhydride may be used alone, or two or more kinds thereof may be used in combination.

In a case where two or more tetracarboxylic dianhydrides are used in combination, either aromatic tetracarboxylic dianhydrides or aliphatic tetracarboxylic dianhydrides may be used in combination, or an aromatic tetracarboxylic dianhydride and an aliphatic tetracarboxylic dianhydride may be used in combination.

Meanwhile, the diamine compound is a diamine compound having two amino groups in the molecular structure. Examples of the diamine compound include an aromatic diamine compound and an aliphatic diamine compound, and for example, an aromatic diamine compound is preferable.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenyl sulfone, 1,5-diaminonaphthalene, 3,3-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl) hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl) biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy) biphenyl, 1,3′-bis(4-aminophenoxy)benzene, 9,9-bis(4-aminophenyl) fluorene, 4,4′-(p-phenylene isopropylidene)bisaniline, 4,4′-(m-phenylene isopropylidene)bisaniline, 2,2′-bis[4-(4-amino-2-trifluoromethylphenoxy)phenyl]hexafluoropropane, and 4,4′-bis[4-(4-amino-2-trifluoromethyl) phenoxy]-octafluorobiphenyl; aromatic diamines having two amino groups bonded to an aromatic ring and a heteroatom other than a nitrogen atom of the amino groups, such as diaminotetraphenylthiophene; and aliphatic diamines and alicyclic diamines such as 1,1-m-xylylenediamine, 1,3-propane diamine, tetramethylenediamine, pentamethylenediamine, octamethylenediamine, nonamethylenediamine, 4,4-diaminoheptamethylenediamine, 1,4-diaminocyclohexane, isophorone diamine, tetrahydrodicyclopentadienylenediamine, hexahydro-4,7-methanoin danylene dimethylenediamine, tricyclo[6,2,1,0^{2.7}]-undecylene dimethyldiamine, and 4,4′-methylenebis(cyclohexylamine).

Among these, as the diamine compound, for example, an aromatic diamine compound is preferable, and specifically, for example, p-phenylenediamine, m-phenylenediamine, 4,4′-diaminodiphenylmethane, 4,4′-diaminodiphenylether, 3,4′-diaminodiphenylether, 4,4′-diaminodiphenylsulfide, or 4,4′-diaminodiphenylsulfone is preferable, and 4,4′-diaminodiphenylether or p-phenylenediamine is particularly preferable.

The diamine compound may be used alone, or two or more kinds thereof may be used in combination.

In a case where two or more diamine compounds are used in combination, either aromatic diamine compounds or aliphatic diamine compounds may be used in combination, or an aromatic diamine compound and an aliphatic diamine compound may be combined.

Among these, from the viewpoint of heat resistance, as the polyimide, for example, an aromatic polyimide (specifically, an imidized polyamic acid (polyimide precursor) that is a polymer of the aromatic tetracarboxylic dianhydride and the aromatic diamine compound) is preferable.

The aromatic polyimide is, for example, more preferably a polyimide having a structural unit represented by General Formula (PI1).

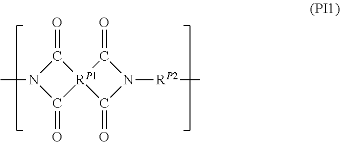

In General Formula (PI1), R^{P1} represents a phenyl group or a biphenyl group, and R^{P2} represents a divalent aromatic group.

Examples of the divalent aromatic group represented by R^{P2} include a phenylene group, a naphthyl group, a biphenyl group, and a diphenyl ether group. As the divalent aromatic group, from the viewpoint of bending durability, for example, a phenylene group or a biphenyl group is preferable.

A number-average molecular weight of the polyimide is, for example, preferably 5,000 or more and 100,000 or less, more preferably 7,000 or more and 50,000 or less, and still more preferably 10,000 or more and 30,000 or less.

The number-average molecular weight of the polyimide is measured by gel permeation chromatography (GPC) under the following measurement conditions.
Column: Tosoh TSK gel α-M (7.8 mm I.D×30 cm)
Eluent: dimethylformamide (DMF)/30 mM LiBr/60 mM phosphoric acid
Flow rate: 0.6 mL/min
Injection amount: 60 μL
Detector: RI (differential refractive index detector)

Examples of the filler include carbon materials such as acetylene black, graphite, graphitized carbon black, and non-graphitized carbon black; and metal nitrides such as aluminum nitride, silicon nitride, boron nitride, cerium oxide, and magnesium carbonate.

As necessary, the base material layer may further contain other additives in addition to the polyimide and filler described above. Examples of the other additives include a softener (paraffin-based softener and the like), a processing aid (stearic acid and the like), an aging inhibitor (amine-based aging inhibitor and the like), and a vulcanizing agent (sulfur, a metal oxide, a peroxide, and the like).

From the viewpoint of thermal conductivity, mechanical strength, and the like, a film thickness of the base material layer is, for example, preferably 30 μm or more and 200 μm or less, and particularly preferably 50 μm or more and 150 μm or less.

The base material layer is obtained by preparing a coating liquid for forming a base material layer, that contains the polyimide (further containing an additive such as a filler), applying the coating liquid for forming a base material layer onto a cylindrical mold, and drying the coating liquid.

### Elastic Layer

The elastic layer contains an elastic material. The elastic layer may contain known additives in addition to the elastic material.

Examples of the elastic material include a fluororesin, a silicone resin, silicone rubber, fluororubber, and fluorosilicone rubber. Among the above, as the elastic material, from the viewpoint of heat resistance, thermal conductivity, insulating properties, and the like, for example, silicone rubber or fluororubber is preferable, and silicone rubber is more preferable.

Examples of the silicone rubber include RTV silicone rubber, HTV silicone rubber, and liquid silicone rubber; and specific examples thereof include polydimethyl silicone rubber (MQ), methyl vinyl silicone rubber (VMQ), methyl phenyl silicone rubber (PMQ), and fluorosilicone rubber (FVMQ).

As the silicone rubber, for example, silicone rubber that is crosslinked generally by an addition reaction is preferable. In addition, various types of functional groups are known for silicone rubber, and for example, dimethyl silicone rubber having a methyl group, methyl phenyl silicone rubber having a methyl group and a phenyl group, vinyl silicone rubber having a vinyl group (vinyl group-containing silicone rubber), or the like is preferable.

Furthermore, as the silicone rubber, for example, vinyl silicone rubber having a vinyl group is more preferable, and silicone rubber that has an organopolysiloxane structure having a vinyl group and a hydrogen organopolysiloxane structure having a hydrogen atom bonded to a silicon atom (SiH) is still more preferable.

Examples of the fluororubber include vinylidene fluoride-based rubber, tetrafluoroethylene/propylene-based rubber, tetrafluoroethylene/perfluoromethyl vinyl ether rubber, phosphazene-based rubber, and fluoropolyether rubber.

For example, it is preferable that the elastic material contains silicone rubber as a principal component (that is, a content of the silicone rubber is, for example, preferably 50% by mass or more with respect to the total mass of the elastic material).

The content of the silicone rubber is, for example, more preferably 90% by mass or more, and still more preferably 99% by mass or more with respect to the total mass of the elastic material used in the elastic layer, and the content of the silicone rubber may be 100% by mass.

The elastic layer may contain additives such as a filler, a softener (such as a paraffin-based softener), a processing aid (such as stearic acid), an antioxidant (such as an amine-based antioxidant), and a vulcanizing agent (such as sulfur, a metal oxide, or a peroxide).

The elastic layer may be formed by a known method, and for example, a coating method is used.

In a case where the silicone rubber is used as the elastic material of the elastic layer, for example, first, a coating liquid for forming an elastic layer, that contains liquid silicone rubber that turns into silicone rubber by being cured by heating, is prepared. Next, the base material layer is coated with the coating liquid for forming an elastic layer to form a coating film, and the coating film is vulcanized as necessary, thereby forming an elastic layer on the base material layer. During the vulcanization of the coating film, a vulcanization temperature is, for example, 150° C. or higher and 250° C. or lower, and the vulcanization time is, for example, 30 minutes or longer and 120 minutes or shorter.

### Average Film Thickness of Surface Layer and Elastic Layer

For example, it is preferable that the fixing member includes an elastic layer and a surface layer on the elastic layer, and an average film thickness of the surface layer is 30 μm or less and an average film thickness of the elastic layer is 300 μm or more. Furthermore, for example, it is more preferable that the average film thickness of the surface layer is 10 μm or more and 50 μm or less, and the average film thickness of the elastic layer is 150 μm or more and 600 μm or less. The fixing properties on the paper having roughness are, for example, preferably such that the surface of the fixing member follows the recessed portion of the paper to a deeper portion, and the followability is improved and the fixing properties are improved by setting the average film thickness of each of the surface layer and the elastic layer within the above-described range.

### Developer

The electrostatic image developer contains a toner in which a number proportion of toner particles having a particle diameter of 4 μm or less is 15% by number or more. Examples of the toner containing a large amount of fine toner particles (that is, toner particles having a particle diameter of 4 μm or less) include a small-diameter toner required to improve image quality of a toner image, or the like. Examples of the small-diameter toner include a toner in which a volume average particle diameter (D50v) of the toner particles is 2 μm or more and 10 μm or less (for example, more preferably 4 μm or more and 8 μm or less).

The number proportion of the toner particles having a particle diameter of 4 μm or less in the toner may be 20% by number or more, 25% by number or more, or 30% by number or more. As the number proportion of the toner particles having a particle diameter of 4 μm or less is higher, the fixing properties on the paper having roughness are deteriorated. On the other hand, in a case where the particle diameter is small, the charging properties are low, and the waste toner increases because the toner is not transferred to the paper, so that the number proportion of the toner particles having a particle diameter of 4 μm or less may be 50% by number or less.

### Various Average Particle Diameters and Various Particle Size Distribution Indexes

Various average particle diameters and various particle size distribution indexes of the toner particles are measured using COULTER MULTISIZER 4e (manufactured by Beckman Coulter, Inc.) and using ISOTON-II (manufactured by Beckman Coulter, Inc.) as an electrolytic solution.

For measurement, a measurement sample in an amount of 0.5 mg or more and 50 mg or less is added to 2 ml of a 5% aqueous solution of a surfactant (for example, preferably sodium alkylbenzene sulfonate) as a dispersant. The obtained solution is added to an electrolytic solution in a volume of 100 ml or more and 150 ml or less.

The electrolytic solution in which the sample is suspended is subjected to a dispersion treatment for 1 minute with an ultrasonic disperser, and the particle size distribution of particles having a particle diameter in a range of 1 μm or more and 30 μm or less is measured using COULTER MULTISIZER 4e with an aperture having an aperture size of 50 μm. The number of particles to be sampled is 50,000.

For the particle size range (channel) divided based on the measured particle size distribution, a cumulative volume distribution and a cumulative number distribution are plotted from small-sized particles. The particle size at which the cumulative percentage of particles is 16% is defined as volume average particle diameter D16v and a number-based particle size D16p. The particle size at which the cumulative percentage of particles is 50% is defined as volume average particle diameter D50v and a cumulative number-average particle size D50p. The particle size at which the cumulative percentage of particles is 84% is defined as volume average particle diameter D84v and a number-based particle size D84p.

By using these, a volume particle size distribution index (GSDv) is calculated as (D84v/D16v)^{1/2}, and a number particle size distribution index (GSDp) is calculated as (D84p/D16p)^{1/2}.

The number proportion of the toner particles having a particle diameter of 4 μm or less is also calculated from the present measurement. From the particle size distribution of the measured number of toner particles, the number proportion of the toner particles having a particle diameter of 4 μm or less with respect to 50,000 measured particles is obtained.

### Toner Particles

The toner particles contain, for example, a binding resin. The toner particles may contain a colorant, a release agent, internally-added resin particles, and other additives.

### Binding Resin

Examples of the binding resin include vinyl-based resins consisting of a homopolymer of a monomer, such as styrenes (for example, styrene, p-chlorostyrene, α-methylstyrene, and the like), (meth)acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, and the like), ethylenically unsaturated nitriles (acrylonitrile, methacrylonitrile, and the like), vinyl ethers (for example, vinyl methyl ether, vinyl isobutyl ether, and the like), vinyl ketones (for example, vinyl methyl ketone, vinyl ethyl ketone, vinyl isopropenyl ketone, and the like), olefins (for example, ethylene, propylene, butadiene, and the like), or a copolymer obtained by combining two or more kinds of monomers described above.

Examples of the binding resin include non-vinyl-based resins such as an epoxy resin, a polyester resin, a polyurethane resin, a polyamide resin, a cellulose resin, a polyether resin, and modified rosin, mixtures of these with the vinyl-based resins, or graft polymers obtained by polymerizing a vinyl-based monomer together with the above resins.

One kind of each of these binding resins may be used alone, or two or more kinds of these binding resins may be used in combination.

As the binding resin, for example, a polyester resin is suitable.

Examples of the polyester resin include known polyester resins. As the polyester resin, a crystalline polyester resin may be used in combination with an amorphous polyester resin. However, a content of the crystalline polyester resin may be, for example, in a range of 2% by mass or more and 40% by mass or less (for example, preferably 2% by mass or more and 30% by mass or less) with respect to all binding resins.

The “crystalline” resin indicates that a clear endothermic peak is present in differential scanning calorimetry (DSC) rather than a stepwise change in endothermic amount and specifically indicates that the half-value width of the endothermic peak in a case of measurement at a temperature rising rate of 10 (° C./min) is within 10° C.

On the other hand, the “amorphous” resin indicates that the half-value width is higher than 10° C., a stepwise change in endothermic amount is shown, or a clear endothermic peak is not recognized.

Examples of the amorphous polyester resin include a polycondensate of a polyvalent carboxylic acid and a polyhydric alcohol. As the amorphous polyester resin, a commercially available product or a synthetic resin may be used.

Examples of the polyvalent carboxylic acid include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, sebacic acid, and the like), alicyclic dicarboxylic acid (for example, cyclohexanedicarboxylic acid and the like), aromatic dicarboxylic acids (for example, terephthalic acid, isophthalic acid, orthophthalic acid, naphthalenedicarboxylic acid, and the like), anhydrides of these, and lower alkyl esters (for example, having 1 or more and 5 or less carbon atoms). Among the polyvalent carboxylic acids, for example, aromatic dicarboxylic acid is preferable.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

One kind of polyvalent carboxylic acid may be used alone, or two or more kinds of polyvalent carboxylic acids may be used in combination.

Examples of the polyhydric alcohol include aliphatic diols (for example, ethylene glycol, diethylene glycol, triethylene glycol, propylene glycol, butanediol, hexanediol, neopentyl glycol, and the like), alicyclic diols (for example, cyclohexanediol, cyclohexanedimethanol, hydrogenated bisphenol A, and the like), and aromatic diols (for example, an ethylene oxide adduct of bisphenol A, a propylene oxide adduct of bisphenol A, and the like). Among the polyhydric alcohols, for example, an aromatic diol or an alicyclic diol is preferable, and an aromatic diol is more preferable.

As the polyhydric alcohol, a polyhydric alcohol having three or more hydroxyl groups and a crosslinked structure or a branched structure may be used in combination with a diol. Examples of the polyhydric alcohol having three or more hydroxyl groups include glycerin, trimethylolpropane, and pentaerythritol.

One kind of polyhydric alcohol may be used alone, or two or more kinds of polyhydric alcohols may be used in combination.

The glass transition temperature (Tg) of the amorphous polyester resin is, for example, preferably 50° C. or higher and 80° C. or lower, and more preferably 50° C. or higher and 65° C. or lower.

The glass transition temperature is determined from a DSC curve obtained by differential scanning calorimetry (DSC). More specifically, the glass transition temperature is determined by “extrapolated glass transition onset temperature” described in the method for determining a glass transition temperature in JIS K 7121-1987, “Testing methods for transition temperatures of plastics”.

The weight-average molecular weight (Mw) of the amorphous polyester resin is, for example, preferably 5,000 or more and 1,000,000 or less, and more preferably 7,000 or more and 500,000 or less.

The number-average molecular weight (Mn) of the amorphous polyester resin is, for example, preferably 2,000 or more and 100,000 or less.

The molecular weight distribution Mw/Mn of the amorphous polyester resin is, for example, preferably 1.5 or more and 100 or less, and more preferably 2 or more and 60 or less.

The weight-average molecular weight and the number-average molecular weight are measured by gel permeation chromatography (GPC). By GPC, the molecular weight is measured using GPC·HLC-8120GPC manufactured by Tosoh Corporation as a measurement device, TSKgel Super HM-M (15 cm) manufactured by Tosoh Corporation as a column, and THF as a solvent. The weight-average molecular weight and the number-average molecular weight are calculated using a molecular weight calibration curve plotted using a monodisperse polystyrene standard sample from the measurement results.

One kind of amorphous polyester resin may be used alone, or two or more kinds of amorphous polyester resins may be used in combination. In a case where two or more kinds thereof are used in combination, for example, a high-molecular-weight form and a low-molecular-weight form may be used in combination.

The amorphous polyester resin is obtained by a known manufacturing method. Specifically, for example, the polyester resin is obtained by a method of setting a polymerization temperature to 180° C. or higher and 230° C. or lower, reducing the internal pressure of a reaction system as necessary, and carrying out a reaction while removing water or an alcohol generated during condensation.

A hybrid resin having a polyester resin segment and a styrene-acrylic copolymer segment may be adopted as the amorphous polyester resin.

Examples of the crystalline polyester resin include a polycondensate of polyvalent carboxylic acid and polyhydric alcohol. As the crystalline polyester resin, a commercially available product or a synthetic resin may be used.

Here, since the crystalline polyester resin easily forms a crystal structure, the crystalline polyester resin is, for example, preferably a polycondensate that is not formed of an aromatic-containing polymerizable monomer but is formed of a linear aliphatic polymerizable monomer.

Examples of the polyvalent carboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (such as phthalic acid, isophthalic acid, terephthalic acid, and naphthalene-2,6-dicarboxylic acid), anhydrides of these dicarboxylic acids, and lower alkyl esters (for example, having 1 or more and 5 or less carbon atoms) of these dicarboxylic acids.

As the polyvalent carboxylic acid, a carboxylic acid having a valency of 3 or more that has a crosslinked structure or a branched structure may be used in combination with a dicarboxylic acid. Examples of the carboxylic acid having a valency of 3 or more include trimellitic acid, pyromellitic acid, anhydrides of these acids, and lower alkyl esters (for example, having 1 or more and 5 or less carbon atoms) of these acids.

As the polyvalent carboxylic acid, a dicarboxylic acid having a sulfonic acid group or a dicarboxylic acid having an ethylenically double bond may be used together with these dicarboxylic acids.

One kind of polyvalent carboxylic acid may be used alone, or two or more kinds of polyvalent carboxylic acids may be used in combination.

Examples of the polyhydric alcohol include an aliphatic diol (for example, a linear aliphatic diol having 2 or more and 20 or less carbon atoms in a main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-icosanediol. Among the aliphatic diols, for example, 1,6-hexanediol, 1,8-octanediol, 1,9-nonanediol, or 1,10-decanediol is preferable.

As the polyhydric alcohol, an alcohol having a valency of 3 or more, that forms a crosslinked structure or a branched structure, may be used in combination with the diol. Examples of the alcohol having a valency of 3 or more include glycerin, trimethylolethane, and trimethylolpropane, pentaerythritol.

One kind of polyhydric alcohol may be used alone, or two or more kinds of polyhydric alcohols may be used in combination.

Here, the content of the aliphatic diol in the polyhydric alcohol may be 80% by mole or more and, for example, preferably 90% by mole or more.

The melting temperature of the crystalline polyester resin is, for example, preferably 50° C. or higher and 100° C. or lower, more preferably 55° C. or higher and 90° C. or lower, and still more preferably 60° C. or higher and 85° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The weight-average molecular weight (Mw) of the crystalline polyester resin is, for example, preferably 6,000 or more and 50,000 or less.

The crystalline polyester resin can be obtained by a known manufacturing method, for example, same as the amorphous polyester resin.

A content of the binding resin with respect to the total amount of the toner particles is, for example, preferably 40% by mass or more and 95% by mass or less, more preferably 50% by mass or more and 90% by mass or less, and still more preferably 60% by mass or more and 90% by mass or less.

### Colorant

Examples of the colorant include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, Dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; inorganic pigments such as a titanium compound, silica, aluminum, and mica; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

The colorant is not limited to a substance having absorption in the visible light region. The colorant may be, for example, a substance having absorption in a near infrared region, a fluorescent colorant, or a colorant having lustrousness.

One kind of colorant may be used alone, or two or more kinds of colorants may be used in combination.

As the colorant, a colorant having undergone a surface treatment as necessary may be used, or a dispersant may be used in combination with the colorant. Furthermore, a plurality of kinds of colorants may be used in combination.

The content of the colorant with respect to the total amount of the toner particles is, for example, preferably 1% by mass or more and 30% by mass or less, and more preferably 3% by mass or more and 15% by mass or less.

### Release Agent

Examples of the release agent include hydrocarbon-based wax; natural wax such as carnauba wax, rice wax, and candelilla wax; synthetic or mineral petroleum-based wax such as montan wax; and ester-based wax such as fatty acid esters and montanic acid esters. As the release agent, for example, paraffin wax is suitable.

A melting temperature of the release agent is, for example, preferably 50° C. or higher and 110° C. or lower, more preferably 60° C. or higher and 100° C. or lower, and still more preferably 75° C. or higher and 95° C. or lower.

The melting temperature is determined from a DSC curve obtained by differential scanning calorimetry (DSC) by “peak melting temperature” described in the method for determining the melting temperature in JIS K 7121-1987, “Testing methods for transition temperatures of plastics”.

The content of the release agent with respect to the total amount of the toner particles is, for example, preferably 1% by mass or more and 20% by mass or less, and more preferably 4% by mass or more and 15% by mass or less.

### Internally-added Resin Particles

Examples of the internally-added resin particles contained as a resin other than the binding resin include internally-added resin particles of a polyolefin-based resin (such as polyethylene and polypropylene), a styrene-based resin (such as polystyrene and α-polymethylstyrene), a (meth)acrylic resin (such as polymethyl methacrylate and polyacrylonitrile), an epoxy resin, a polyurethane resin, a polyurea resin, a polycarbonate resin, a polyether resin, a polyester resin, copolymer resins of these compounds, and the like.

As the internally-added resin particles, for example, styrene-(meth)acrylic copolymer resin particles are preferable.

Examples of the styrene-(meth)acrylic copolymer resin particles include resin particles obtained by polymerizing a styrene-based monomer and a (meth)acrylic acid-based monomer by radical polymerization.

Examples of the styrene-based monomer include styrene, α-methylstyrene, vinylnaphthalene; alkyl-substituted styrene with an alkyl chain, such as 2-methylstyrene, 3-methylstyrene, 4-methylstyrene, 2-ethylstyrene, 3-ethylstyrene, and 4-ethylstyrene; halogen-substituted styrene such as 2-chlorostyrene, 3-chlorostyrene, and 4-chlorostyrene; and fluorine-substituted styrene such as 4-fluorostyrene and 2,5-difluorostyrene. Among these, as the styrene-based monomer, for example, styrene or α-methylstyrene is preferable.

Examples of the (meth)acrylic acid-based monomer include (meth)acrylic acid, n-methyl (meth)acrylate, n-ethyl (meth)acrylate, n-propyl (meth)acrylate, n-butyl (meth)acrylate, n-pentyl (meth)acrylate, n-hexyl (meth)acrylate, n-heptyl (meth)acrylate, n-octyl (meth)acrylate, n-decyl (meth)acrylate, n-dodecyl (meth)acrylate, n-lauryl (meth)acrylate, n-tetradecyl (meth)acrylate, n-hexadecyl (meth)acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth)acrylate, isooctyl (meth)acrylate, 2-ethylhexyl (meth)acrylate, phenyl (meth)acrylate, biphenyl (meth)acrylate, diphenylethyl (meth)acrylate, t-butylphenyl (meth)acrylate, terphenyl (meth)acrylate, cyclohexyl (meth)acrylate, t-butylcyclohexyl (meth)acrylate, dimethylaminoethyl (meth)acrylate, diethylaminoethyl (meth)acrylate, methoxyethyl (meth)acrylate, 2-hydroxyethyl (meth)acrylate, β-carboxyethyl (meth)acrylate, (meth)acrylonitrile, and (meth)acrylamide. Among these, as the (meth)acrylic acid-based monomer, for example, n-butyl (meth)acrylate or β-carboxyethyl (meth)acrylate is preferable.

As the internally-added resin particles, for example, crosslinked resin particles are preferable. Examples of a crosslinking agent for crosslinking the resin in the crosslinked resin particles include aromatic polyvalent vinyl compounds such as divinylbenzene and divinyl naphthalene; polyvalent vinyl esters of aromatic polycarboxylic acids such as divinyl phthalate, divinyl isophthalate, divinyl terephthalate, divinyl homophthalate, divinyl trimellitate, trivinyl trimellitate, divinyl naphthalenedicarboxylate, and divinyl biphenylcarboxylate; divinyl esters of nitrogen-containing aromatic compounds such as divinyl pyridine dicarboxylate; vinyl esters of unsaturated heterocyclic carboxylic acid compounds such as vinyl pyromucate, vinyl furancarboxylate, vinyl pyrrole-2-carboxylate, and vinyl thiophenecarboxylate; (meth)acrylic acid esters of linear polyhydric alcohols such as butanediol dimethacrylate, hexanediol diacrylate, hexanediol dimethacrylate, octanediol diacrylate, octanediol dimethacrylate, nonanediol diacrylate, nonanediol dimethacrylate, decanediol diacrylate, decanediol dimethacrylate, dodecanediol diacrylate, and dodecanediol dimethacrylate; (meth)acrylic acid esters of branched or substituted polyhydric alcohols such as neopentyl glycol dimethacrylate and 2-hydroxy-1,3-diacryloxypropane; and polyethylene glycol di(meth)acrylates and polypropylene polyethylene glycol di(meth)acrylates. One kind of crosslinking agent may be used alone, or two or more kinds of crosslinking agents may be used in combination.

The styrene-based monomer and the (meth)acrylic acid-based monomer are, for example, resin particles in which the styrene-based monomer is styrene and the (meth)acrylic acid-based monomer is n-butyl acrylate, and a mass ratio (styrene-based monomer/(meth)acrylic acid-based monomer) of the styrene-based monomer to the (meth)acrylic acid-based monomer is 70/30 or more and 10/90 or less (for example, preferably 65/35 or more and 20/80 or less).

An average primary particle diameter of the internally-added resin particles is, for example, preferably 50 nm or more and 500 nm or less, more preferably 20 nm or more and 300 nm or less, and still more preferably 30 nm or more and 250 nm or less.

In a case where the average primary particle diameter of the internally-added resin particles is within the above-described range, the internally-added resin particles are less likely to aggregate in the toner particles, and the internally-added resin particles are likely to be present in an appropriate size.

The average primary particle diameter of the internally-added resin particles is a value measured using a transmission electron microscope (TEM).

As the transmission electron microscope, for example, JEM-2100plus manufactured by JEOL Ltd. is used.

Specifically, a method of measuring the average primary particle diameter of the internally-added resin particles is as follows.

The toner particles are cut in a thickness of approximately 0.1 μm with a microtome. A cross section of the toner particles is imaged at 10,000× magnification by using the transmission electron microscope, equivalent circle diameters of 100 internally-added resin particles dispersed in the toner particles are calculated based on the cross-sectional areas of the particles, and an arithmetic average thereof is calculated and adopted as the average primary particle diameter.

A content of the internally-added resin particles with respect to the toner particles is, for example, preferably 2% by mass or more and 30% by mass or less, more preferably 3% by mass or more and 25% by mass or less, and still more preferably 5% by mass or more and 20% by mass or less.

### Other Additives

Examples of other additives include well-known additives such as a magnetic material, a charge control agent, and inorganic powder. The additives are incorporated into the toner particles as internal additives.

Characteristics and the like of Toner Particles

The toner particles may be toner particles that have a single-layer structure or toner particles having a so-called core/shell structure that is configured with a core portion (core particle) and a coating layer (shell layer) coating the core portion.

Here, the toner particles having a core/shell structure may be, for example, configured with a core portion that is configured with the binding resin, and the colorant, the release agent, and other additives as necessary, and a coating layer that is configured with the binding resin, where the coating layer may have a multilayer structure, and the type of the binding resin, the presence or absence or the type of the colorant or the release agent may be changed by the core portion or each coating layer.

From the viewpoint of achieving both thin line reproducibility and transfer efficiency, a volume average particle diameter (D50v) of the toner particles is, for example, preferably 2 μm or more and 10 μm or less, and more preferably 4 μm or more and 8 μm or less.

An average circularity of the toner particles is, for example, preferably 0.90 or more and 1.00 or less, and more preferably 0.92 or more and 0.98 or less.

The average circularity of the toner particles is determined by (Equivalent circular perimeter)/(Perimeter) [(Perimeter of circle having the same projected area as particle image)/(Perimeter of projected particle image)]. Specifically, the average circularity is a value measured by the following method.

First, toner particles as a measurement target are collected by suction, and a flat flow of the particles is formed. Thereafter, an instant flash of strobe light is emitted to the particles, and the particles are imaged as a still image. By using a flow-type particle image analyzer (Parshe Analyzer PAS, manufactured by HOSOKAWA MICRON CORPORATION) performing image analysis on the particle image, the average circularity is determined. The number of samplings for determining the average circularity is 10,000.

In a case where a toner contains the external additive, the toner (developer) as a measurement target is dispersed in water containing a surfactant, then the dispersion is treated with ultrasonic waves such that the external additive is removed, and the toner particles are collected.

### External Additive

Examples of the external additive include inorganic particles. Examples of the inorganic particles include SiO₂, TiO₂, Al₂O₃, SrTiO₃, CaTiO₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surface of the inorganic particles as an external additive may have undergone, for example, a hydrophobization treatment. The hydrophobization treatment is performed, for example, by dipping the inorganic particles in a hydrophobic agent. The hydrophobic agent is not particularly limited, and examples thereof include a silane-based coupling agent, silicone oil, a titanate-based coupling agent, and an aluminum-based coupling agent. One kind of each of the agents may be used alone, or two or more kinds of the agents may be used in combination.

Usually, the amount of the hydrophobic agent is, for example, 1 part by mass or more and 10 parts by mass or less with respect to 100 parts by mass of the inorganic particles.

Examples of the external additive also include resin particles (resin particles such as polystyrene, polymethylmethacrylate (PMMA), and melamine resins), a cleaning lubricant (for example, a metal salt of a higher fatty acid represented by zinc stearate or particles of higher alcohols).

From the viewpoint of improving fluidity of the toner particles, a volume average particle diameter (primary particle diameter) of the external additive is, for example, preferably 1 nm or more and 500 nm or less, more preferably 10 nm or more and 400 nm or less, and still more preferably 20 nm or more and 200 nm or less.

The volume average particle diameter of the external additive is measured using a laser diffraction type particle size distribution analyzer (LA-700, manufactured by HORIBA, Ltd.).

As a measuring method, a sample in a dispersed liquid state is adjusted to 2 g in terms of solid content, and deionized water is added thereto to be 40 ml. The solution is charged into a cell until the sample has an appropriate concentration, and is measured after waiting for 2 minutes until the concentration in the cell is stabilized. A cumulative distribution is drawn from a small diameter side for each of volume in a particle size range (channel) divided based on the measured particle size distribution, and a particle diameter at which the cumulative distribution is 50% by volume is defined as the volume average particle diameter.

In a case of measuring a powder such as the external additive, 2 g of the measurement sample is added to 50 ml of a 5% by mass aqueous solution of a surfactant (for example, preferably sodium alkylbenzenesulfonate), the mixture is dispersed for 2 minutes with an ultrasonic disperser (1,000 Hz) to prepare a sample, and the sample is measured by the same method as the above-described dispersion.

From the viewpoint of improving the fluidity of the toner particles, an addition amount of the entire external additive is, for example, preferably 2 parts by mass or more and 10 parts by mass or less, more preferably 3 parts by mass or more and 7 parts by mass or less, and still more preferably 4 parts by mass or more and 6 parts by mass or less with respect to 100 parts by mass of the toner particles.

The amount of the external additive externally added with respect to the toner particles is, for example, preferably 0.01% by mass or more and 10% by mass or less, and more preferably 0.01% by mass or more and 6.0% by mass or less.

### Manufacturing Method of Toner

Next, the manufacturing method of the toner using the present exemplary embodiment will be described.

The toner using the present exemplary embodiment is obtained by manufacturing toner particles and then externally adding external additives to the toner particles.

The toner particles may be manufactured by any of a dry manufacturing method (for example, a kneading and pulverizing method or the like) or a wet manufacturing method (for example, an aggregation and coalescence method, a suspension polymerization method, a dissolution suspension method, or the like). The manufacturing method of the toner particles is not particularly limited to the manufacturing methods, and a well-known manufacturing method is adopted.

Among these, for example, the aggregation and coalescence method is preferable for reducing the diameter of the toner particles and controlling the amount of fine toner particles.

A method of controlling the number proportion of the fine toner particles, that is, the toner particles having a particle diameter of 4 μm or less is not particularly limited, and for example, can be adjusted by pulverization and classification in the kneading and pulverizing method of the dry method, or by changing the amount of an aggregating agent or the solid contained ratio in the first coagulation particle forming step of the aggregation and coalescence method in the wet method.

In a case of using the kneading and pulverizing method, for example, the material kneaded mixture is pulverized by a known method, and then the number proportion of the toner particles having a particle diameter of 4 μm or less can be adjusted by changing a classification edge position using an elbow jet classifier (manufactured by Matsubo Corporation) in the classification step.

In a case of using the aggregation and coalescence method, for example, the number proportion of the toner particles having a particle diameter of 4 μm or less is adjusted (reduced) by increasing the amount of the aggregating agent added in the first coagulation step to strengthen the coagulation force. In addition, the number proportion of the toner particles having a particle diameter of 4 μm or less is adjusted (reduced) by increasing the solid contained ratio in the first coagulation step.

Specifically, in a case where the toner particles are manufactured by the aggregation and coalescence method, for example,
a step of mixing a first resin particle dispersion in which first resin particles as the binder resin are dispersed, a colorant dispersion in which colorants are dispersed, and a release agent particle dispersion in which particles of the release agent (hereinafter, also referred to as “release agent particles”) are dispersed to aggregate each particle and colorant in the obtained dispersions, thereby forming first aggregated particles (first aggregated particle-forming step);
a step of, after obtaining the first aggregated particle dispersion in which the first aggregated particles are dispersed, adding second resin particles as the binder resin to the first aggregated particle dispersion to aggregate the second resin particles on a surface of the first aggregated particles, thereby forming second aggregated particles (second aggregated particle-forming step);
a step of coalescing the second aggregated particles by heating the second aggregated particle dispersion in which the second aggregated particles are dispersed, thereby forming toner particles (coalescence step)
are performed to manufacture the toner particles.

The present aggregation and coalescence method will be described as a method for producing toner particles containing a binding resin, a colorant, and a release agent; but the colorant and the release agent are components to be contained in the toner particles as necessary.

Hereinafter, each of the steps will be specifically described.

### Each Dispersion Preparing Step

First, each dispersion to be used in the aggregation and coalescence method is prepared. Specifically, a first resin particle dispersion in which first resin particles as a binding resin are dispersed, a colorant dispersion in which a colorant is dispersed, a second resin particle dispersion in which second resin particles as a binding resin are dispersed, and a release agent particle dispersion in which release agent particles are dispersed are respectively prepared.

In each dispersion preparing step, the first resin particles and the second resin particles will be referred to as “resin particles” in the following description.

The resin particle dispersion is prepared, for example, by dispersing the resin particles in a dispersion medium by using a surfactant.

Examples of the dispersion medium used for the resin particle dispersion include an aqueous medium.

Examples of the aqueous medium include distilled water, water such as deionized water, alcohols, and the like. One kind of each of the media may be used alone, or two or more kinds of the media may be used in combination.

Examples of the surfactant include an anionic surfactant based on a sulfuric acid ester salt, a sulfonate, a phosphoric acid ester, soap, and the like; a cationic surfactant such as an amine salt-type cationic surfactant and a quaternary ammonium salt-type cationic surfactant; a nonionic surfactant based on polyethylene glycol, an alkylphenol ethylene oxide adduct, and a polyhydric alcohol, and the like. Among these, an anionic surfactant and a cationic surfactant are particularly mentioned. The nonionic surfactant may be used in combination with an anionic surfactant or a cationic surfactant.

One kind of surfactant may be used alone, or two or more kinds of surfactants may be used in combination.

As for the resin particle dispersion, examples of the method for dispersing the resin particles in the dispersion medium include general dispersion methods such as a rotary shearing homogenizer, a ball mill having media, a sand mill, and a dyno mill. Depending on the type of resin particles, the resin particles may be dispersed in the resin particle dispersion by using, for example, a transitional phase inversion emulsification method.

The transitional phase inversion emulsification method is a method of dissolving a resin to be dispersed in a hydrophobic organic solvent in which the resin is soluble, adding a base to an organic continuous phase (O phase) for causing neutralization, and then adding an aqueous medium (W phase), such that the resin undergoes conversion (so-called phase inversion) from W/O to O/W, turns into a discontinuous phase, and is dispersed in the aqueous medium in the form of particles.

The volume average particle diameter of the resin particles dispersed in the resin particle dispersion is, for example, preferably 0.01 μm or more and 1 μm or less, more preferably 0.03 μm or more and 0.8 μm or less, and still more preferably 0.05 μm or more and 0.6 μm or less.

For determining the volume average particle diameter of the resin particles, a particle size distribution is measured using a laser diffraction type particle size distribution analyzer (for example, LA-960 manufactured by HORIBA, Ltd.), a volume-based cumulative distribution from small-sized particles is drawn for the particle size range (channel) divided using the particle size distribution, and the particle size of particles accounting for cumulative 50% of all particles is measured as a volume average particle diameter D50v. For particles in other dispersions, the volume average particle diameter is measured in the same manner.

The content of the resin particles contained in the resin particle dispersion is, for example, preferably 5% by mass or more and 50% by mass or less, and more preferably 10% by mass or more and 40% by mass or less.

For example, a colorant dispersion and a release agent particle dispersion are prepared in the same manner as that adopted for preparing the resin particle dispersion. That is, the volume average particle diameter of the particles, the dispersion medium, the dispersion method, and the content of the particles in the resin particle dispersion are also applied to the colorant to be dispersed in the colorant dispersion and the release agent particles to be dispersed in the release agent particle dispersion.

### First Aggregated Particle-Forming Step

Next, the first resin particle dispersion is mixed with the colorant dispersion and the release agent particle dispersion.

In the mixed dispersion, the first resin particles, the colorant, and the release agent particles are hetero-aggregated to form the first aggregated particles including the first resin particles, the colorant, and the release agent particles.

Specifically, for example, an aggregating agent is added to a dispersion obtained by mixing the first resin particle dispersion, the colorant dispersion, and the release agent particle dispersion; the pH of the mixed dispersion is adjusted to acidic (for example, pH of 2 or more and 5 or less); a dispersion stabilizer is added thereto as necessary; the temperature is set to a temperature region of 20° C. or higher and 50° C. or lower; and the particles dispersed in the mixed dispersion are aggregated to form the first aggregated particles.

In the first aggregated particle-forming step, for example, in a state where the mixed dispersion is stirred with a rotary shearing homogenizer, the aggregating agent may be added thereto at room temperature (for example, 25° C.), the pH of the mixed dispersion may be adjusted such that the dispersion is acidic (for example, pH of 2 or higher and 5 or lower), a dispersion stabilizer may be added to the dispersion as necessary, and then the dispersion may be heated.

Examples of the aggregating agent include a surfactant having polarity opposite to the polarity of the surfactant used as a dispersant added to the mixed dispersion, an inorganic metal salt, and a metal complex having a valency of 2 or higher. In particular, in a case where a metal complex is used as the aggregating agent, the amount of the surfactant used is reduced, and the charging characteristics are improved.

An additive that forms a complex or a bond similar to the complex with a metal ion of the aggregating agent may be used as necessary. As such an additive, a chelating agent is used.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may also be used. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added with respect to 100 parts by mass of the first resin particles is, for example, preferably 0.01 parts by mass or more and 5.0 parts by mass or less, and more preferably 0.1 parts by mass or more and less than 3.0 parts by mass.

In addition, in order to adjust the effect of the chelating agent, an alkali may be added to adjust the pH in the system.

### Second Aggregated Particle-Forming Step

Next, after obtaining the first aggregated particle dispersion in which the first aggregated particles are dispersed, a second resin particle dispersion in which second resin particles are dispersed is added to the first aggregated particle dispersion.

The second resin particles may be of the same type as the first resin particles, or may be of different types.

Next, the second resin particles are aggregated on the surface of the first aggregated particles in the dispersion of the first aggregated particles and the second resin particles. In this case, by adding the release agent particle dispersion, the second resin particles and the release agent particles may be aggregated on the surface of the first aggregated particles. Specifically, for example, in the first aggregated particle-forming step, in a case where the first aggregated particles reach a target particle size, the second resin particle dispersion is added to the first aggregated particle dispersion, and the mixture is heated at a temperature equal to or lower than the glass transition temperature of the second resin particles.

By setting the pH of the dispersion in a range of, for example, about 6.5 or more and 8.5 or less, the progress of aggregation is stopped.

In this way, the second aggregated particles are obtained in which the second resin particles are aggregated so as to adhere to the surface of the first aggregated particles.

### Coalescence Step

Next, the second aggregated particle dispersion in which the second aggregated particles are dispersed is heated to, for example, a temperature equal to or higher than the glass transition temperatures of the first and second amorphous resin particles (for example, a temperature higher than the glass transition temperatures of the first and second resin particles by 10° C. to 30° C.) such that the second aggregated particles coalesce, thereby forming toner particles.

In addition, in order to control the shape, the pH in the system may be adjusted by adding an acid as necessary.

The toner particles are obtained through the above steps.

In the aggregation and coalescence method described above, the first aggregated particles may be coalesced to form the toner particles without performing the second aggregated particle-forming step. In addition, the second aggregated particle-forming step may be repeatedly performed a plurality of times, or the second aggregated particle-forming step may be performed a plurality of times by changing the type of the binding resin, the presence or absence or the type of the colorant or the release agent.

After the coalescence step, the toner particles formed in a solution undergo a known washing step, solid-liquid separation step, and drying step, thereby obtaining dry toner particles.

The washing step is not particularly limited. However, in view of charging properties, displacement washing may be thoroughly performed using deionized water. The solid-liquid separation step is not particularly limited. However, in view of productivity, suction filtration, pressure filtration, or the like may be performed. Furthermore, the method of the drying step is not particularly limited. However, in view of productivity, freeze drying, flush drying, fluidized drying, vibratory fluidized drying, or the like may be performed.

For example, by adding an external additive to the obtained dry toner particles and mixing the external additive and the toner particles together, the toner used in the present exemplary embodiment is manufactured. The mixing may be performed, for example, using a V blender, a Henschel mixer, a Lödige mixer, or the like. In addition, the external additive may be mixed with the toner particles at once, or the external additive may be added to the toner particles stepwise and mixed a plurality of times. Furthermore, coarse particles of the toner may be removed as necessary by using a vibratory sieving machine, a pneumatic sieving machine, or the like.

### Electrostatic Image Developer

The electrostatic image developer used in the present exemplary embodiment contains at least a toner.

The electrostatic image developer used in the present exemplary embodiment may be a one-component developer that contains only the toner or a two-component developer that is obtained by mixing the toner and a carrier together.

The carrier is not particularly limited, and examples thereof include known carriers. Examples of the carrier include a coated carrier obtained by coating the surface of a core material consisting of magnetic powder with a coating resin; a magnetic powder dispersion-type carrier obtained by dispersing magnetic powder in a matrix resin and mixing the powder and the resin together; and a resin impregnation-type carrier obtained by impregnating porous magnetic powder with a resin.

Each of the magnetic powder dispersion-type carrier and the resin impregnation-type carrier may be a carrier obtained by coating a core material, that are particles configuring the carrier, with a coating resin.

Examples of the magnetic powder include magnetic metals such as iron, nickel, and cobalt; and magnetic oxides such as ferrite and magnetite. In particular, as a magnetic powder, for example, magnetite or ferrite is preferable. The magnetic powder may be used as particles in which the magnetic powder is dispersed in a resin.

Examples of the coating resin and the matrix resin include a styrene (meth)acrylic acid resin; polyolefin-based resins such as a polyethylene resin and a polypropylene resin; polyvinyl-based or polyvinylidene-based resins such as polystyrene, a (meth)acrylic resin, polyacrylonitrile, polyvinyl acetate, polyvinyl alcohol, polyvinyl butyral, polyvinyl chloride, polyvinylcarbazole, polyvinyl ether, or polyvinyl ketone; a vinyl chloride vinyl acetate copolymer; a straight silicone resin consisting of an organosiloxane bond or a modified product thereof; a fluororesin such as polytetrafluoroethylene, polyvinyl fluoride, polyvinylidene fluoride, or polychlorotrifluoroethylene; polyester; polyurethane; polycarbonate; an amino resin such as a urea formaldehyde resin; and an epoxy resin.

For example, the coating resin and the matrix resin preferably contain a (meth)acrylic resin, and preferably contain a (meth)acrylic resin having an alicyclic structure. The coating resin and the matrix resin may contain a nitrogen-containing (meth)acrylic resin.

A content of the (meth)acrylic resin is, for example, more preferably 50% by mass or more, and still more preferably 80% by mass or more with respect to the total mass of the resins.

In particular, for example, the coating resin and the matrix resin preferably contain an alicyclic (meth)acrylic resin as the (meth)acrylic resin.

The coating resin and the matrix resin may contain other additives such as conductive particles.

Examples of the conductive particles include metals such as gold, silver, and copper, and particles such as carbon black, titanium oxide, zinc oxide, tin oxide, barium sulfate, aluminum borate, and potassium titanate.

Examples of the other additives include particles overlapping with the above-described conductive particles, but also include metal oxide particles such as silica, titanium oxide, zinc oxide, and tin oxide; metal compound particles such as barium sulfate, aluminum borate, and potassium titanate; and metal particles such as gold, silver, and copper. Among the above, for example, silica particles are preferable.

A content of the above-described particles is, for example, preferably 10% by mass or more and 60% by mass or less with respect to the total mass of the resin layer.

The surface of the core material is coated with a coating resin, for example, by a coating method using a solution for forming a coating layer obtained by dissolving the coating resin and various additives, that are used as necessary, in an appropriate solvent, and the like. The solvent is not particularly limited, and may be selected in consideration of the type of the coating resin used, coating suitability, and the like.

Specifically, examples of the resin coating method include a dipping method of dipping the core material in the solution for forming a coating layer; a spray method of spraying the solution for forming a coating layer to the surface of the core material; a fluidized bed method of spraying the solution for forming a coating layer to the core material that is floating by an air flow; and a kneader coater method of mixing the core material of the carrier with the solution for forming a coating layer in a kneader coater and removing solvents.

The mixing ratio (mass ratio) between the toner and the carrier, represented by toner:carrier, in the two-component developer is, for example, preferably 1:100 to 30:100, and more preferably 3:100 to 20:100.

### Fixing Device

Examples of the fixing device according to the present exemplary embodiment include a fixing device that includes a fixing member, a rotating body disposed in contact with an outer peripheral surface of the fixing member, and a pressing member disposed inside the fixing member and pressing the fixing member toward the rotatable body from an inner peripheral surface of the fixing member. As the fixing member, the fixing member according to the present exemplary embodiment is applied.

Hereinafter, an example of the fixing device according to the present exemplary embodiment will be described with reference to the drawing.

### First Exemplary Embodiment of Fixing Device

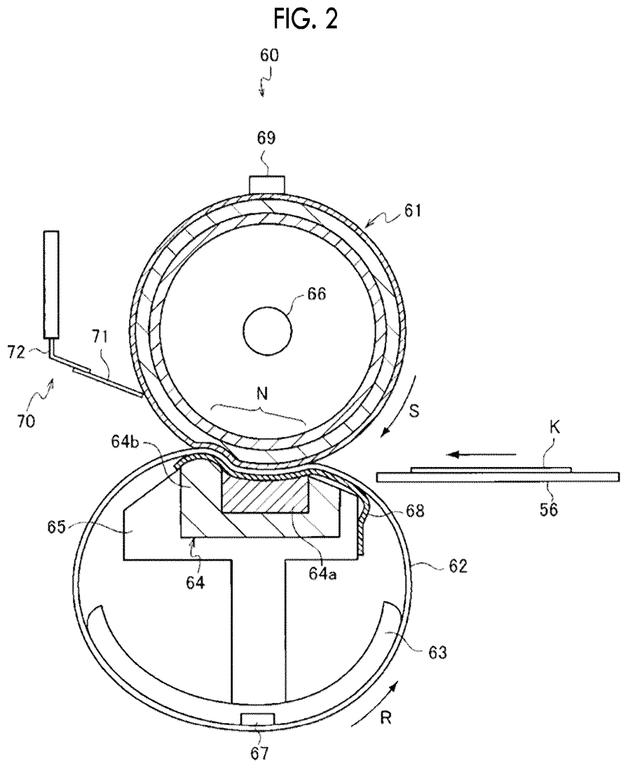

The first exemplary embodiment of the fixing device will be described with reference to FIG. 2. FIG. 2 is a schematic view showing a configuration of an example (that is, a fixing device 60) of the fixing device according to the first exemplary embodiment.

As shown in FIG. 2, the fixing device 60 is configured, for example, with a heating roll 61 (an example of the rotating body) that is driven to rotate, a pressurizing belt 62 (an example of the fixing member), and a pressing pad 64 (an example of a pressing member) that presses the heating roll 61 through the pressurizing belt 62.

Regarding the pressing pad 64, for example, the pressurizing belt 62 and the heating roll 61 may be relatively pressed. Therefore, the pressurizing belt 62 may be pressed against the heating roll 61, or the heating roll 61 may be pressed against the pressurizing belt 62.

A halogen lamp 66 (an example of a heating device) is disposed inside the heating roll 61. The heating unit is not limited to the halogen lamp, and other heating members that generate heat may be used.

Meanwhile, for example, a temperature-sensitive element 69 is disposed in contact with a surface of the heating roll 61. The lighting of the halogen lamp 66 is controlled based on a temperature measurement value by the temperature-sensitive element 69, and a surface temperature of the heating roll 61 is kept at a target set temperature (for example, 170° C.).

For example, the pressurizing belt 62 is rotatably supported by the pressing pad 64 and a belt traveling guide 63 that are disposed inside the pressurizing belt 62. In a sandwiching region N (nip portion), the pressurizing belt 62 is disposed to be pressed against the heating roll 61 by the pressing pad 64.

The pressing pad 64 is, for example, disposed in a state of being pressed against the heating roll 61 through the pressurizing belt 62 inside the pressurizing belt 62, and forms the sandwiching region N with the heating roll 61.

In the pressing pad 64, for example, a front sandwiching member 64a for securing a wide sandwiching region N is disposed on the inlet side of the sandwiching region N, and a peeling sandwiching member 64b for imparting distortion to the heating roll 61 is disposed on the outlet side of the sandwiching region N.

In order to reduce sliding resistance between an inner peripheral surface of the pressurizing belt 62 and the pressing pad 64, for example, a sheet-like sliding member 68 is provided on surfaces of the front sandwiching member 64a and the peeling sandwiching member 64b in contact with the pressurizing belt 62. The pressing pad 64 and the sliding member 68 are held by a metal holding member 65.

For example, the belt traveling guide 63 is attached to the holding member 65, and the pressurizing belt 62 is configured to rotate.

The heating roll 61 rotates, for example, in a direction of an arrow S by a drive motor (not shown), and following the above rotation, the pressurizing belt 62 rotates in a direction of an arrow R, opposite to the rotation direction of the heating roll 61. That is, for example, the heating roll 61 rotates clockwise in FIG. 2, while the pressurizing belt 62 rotates counterclockwise.

Paper K (an example of a recording medium) having an unfixed toner image is guided by, for example, a fixing inlet guide 56, and transported to the sandwiching region N. While the paper K is passing through the sandwiching region N, the unfixed toner image on the paper K is fixed by the pressure and heat acting on the sandwiching region N.

In the fixing device 60, for example, by the front sandwiching member 64a in the form of a recess conforming to an outer peripheral surface of the heating roll 61, the wide sandwiching region Nis secured, compared to a configuration having no front sandwiching member 64a.

In addition, in the fixing device 60, for example, the peeling sandwiching member 64b is disposed to protrude from the outer peripheral surface of the heating roll 61 such that the distortion of the heating roll 61 is locally increased in an outlet region of the sandwiching region N.

In a case where the peeling sandwiching member 64b is disposed as described above, for example, the paper K after the fixing passes through a distortion portion formed locally large in a case of passing through the peeling sandwiching region, and thus the paper K is easy to be peeled off from the heating roll 61.

As an auxiliary unit for the peeling, for example, a peeling member 70 is disposed on the downstream side of the sandwiching region N of the heating roll 61. The peeling member 70 is, for example, held by a holding member 72 in a state in which a peeling claw 71 is close to the heating roll 61 in a direction facing the rotation direction of the heating roll 61 (counter direction).

### Second Exemplary Embodiment of Fixing Device

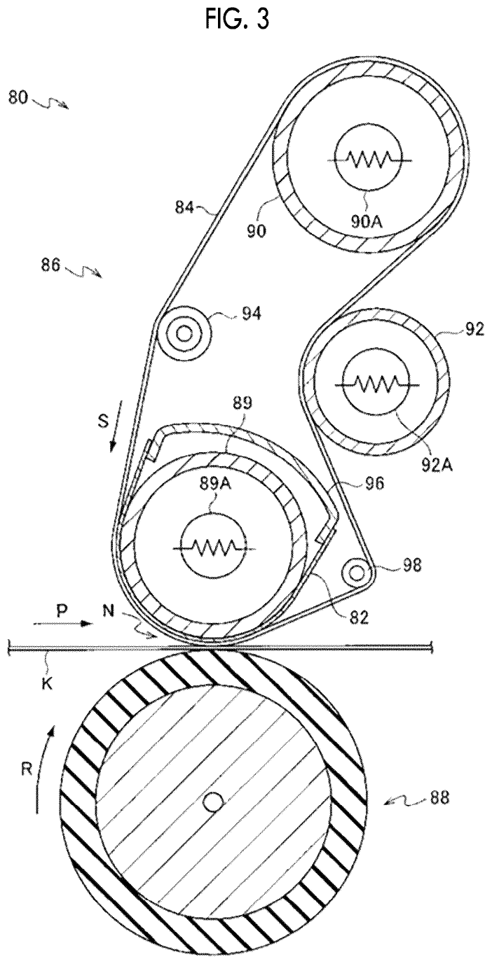

The second exemplary embodiment of the fixing device will be described with reference to FIG. 3. FIG. 3 is a schematic view showing an example (that is, a fixing device 80) of the fixing device according to the second exemplary embodiment.

As shown in FIG. 3, the fixing device 80 is configured, for example, with a fixing belt module 86 including a heating belt 84 (an example of the fixing member) and a pressurizing roll 88 (an example of the rotating body) arranged in a state of being pressed on a heating belt 84 (fixing belt module 86). For example, a sandwiching region N (nip portion) is formed in a contact portion between the heating belt 84 (the fixing belt module 86) and the pressurizing roll 88. In the sandwiching region N, paper K (an example of the recording medium) is pressed and heated, and the toner image is fixed.

The fixing belt module 86 includes, for example, an endless heating belt 84, a heating and pressing roll 89 (an example of the pressing member) around which the heating belt 84 is wound on the side of the pressurizing roll 88 and which is driven to rotate by the rotational force of a motor (not shown) and presses the heating belt 84 from an inner peripheral surface thereof toward the pressurizing roll 88, and a support roll 90 which supports the heating belt 84 from the inside at a position different from the heating and pressing roll 89.

The fixing belt module 86 is provided with, for example, a support roll 92 that is disposed outside the heating belt 84 and defines a circulating path thereof, a posture correction roll 94 that corrects the posture of the heating belt 84 from the heating and pressing roll 89 to the support roll 90, and a support roll 98 that applies a tension to the heating belt 84 from the inner peripheral surface on the downstream side of the sandwiching region N that is a region formed by the heating belt 84 and the pressurizing roll 88.

The fixing belt module 86 is provided, for example, such that a sheet-shaped sliding member 82 is interposed between the heating belt 84 and the heating and pressing roll 89. The sliding member 82 is provided, for example, such that a sliding surface thereof is in contact with the inner peripheral surface of the heating belt 84, and is involved in holding and supplying an oil present between the sliding member 82 and the heating belt 84. Here, the sliding member 82 is provided, for example, in a state in which both ends thereof are supported by a support member 96.

For example, a halogen heater 89A (an example of the heating device) is provided inside the heating and pressing roll 89.

The support roll 90 is, for example, a cylindrical roll made of aluminum, and a halogen heater 90A (an example of the heating device) is disposed therein, so that the heating belt 84 is heated from the inner peripheral surface side.

At both ends of the support roll 90, for example, spring members (not shown) pressing the heating belt 84 outward are disposed.

The support roll 92 is, for example, a cylindrical roll formed of aluminum, and a release layer consisting of a fluororesin having a thickness of 20 μm is formed on a surface of the support roll 92.

The release layer of the support roll 92 is formed, for example, for preventing a toner or paper dust from the outer peripheral surface of the heating belt 84 from accumulating on the support roll 92.

For example, a halogen heater 92A (an example of the heating device) is disposed inside the support roll 92 so that the heating belt 84 is heated from the outer peripheral surface side.

That is, for example, the heating and pressing roll 89, the support roll 90, and the support roll 92 are configured to heat the heating belt 84.

The posture correction roll 94 is, for example, a columnar roll made of aluminum, and an end position measurement mechanism (not shown) for measuring the end position of the heating belt 84 is disposed in the vicinity of the posture correction roll 94.

In the posture correction roll 94, for example, an axial direction displacement mechanism (not shown) that displaces a contact position of the heating belt 84 in an axial direction according to the measurement result of the end position measurement mechanism is disposed, and the posture correction roll 94 is configured to control meandering of the heating belt 84.

Meanwhile, the pressurizing roll 88 is, for example, rotatably supported, and the heating belt 84 is provided to be pressed against a portion wound around the heating and pressing roll 89 by an urging device such as a spring (not shown). As a result, as the heating belt 84 (heating and pressing roll 89) of the fixing belt module 86 moves rotationally in the direction of the arrow S, the pressurizing roll 88 follows the heating belt 84 (heating and pressing roll 89) and moves rotationally in the direction of the arrow R.

The paper K having an unfixed toner image (not shown) is transported in a direction of an arrow P and is guided to the sandwiching region N of the fixing device 80. While the paper K is passing through the sandwiching region N, the unfixed toner image on the paper K is fixed by the pressure and heat acting on the sandwiching region N.

For the fixing device 80, embodiments in which a halogen heater (halogen lamp) is used as an example of a plurality of heating devices is described; but the fixing device is not limited thereto, and a radiation lamp heating element (a heating element generating radiation (such as infrared rays)) and a resistance heating element (a heating element generating Joule heat by passing an electric current through a resistor; for example, a heating element obtained by forming a film with a resistor on a ceramic substrate and baking the resultant) other than the halogen heater may be used.

### Third Exemplary Embodiment of Fixing Device

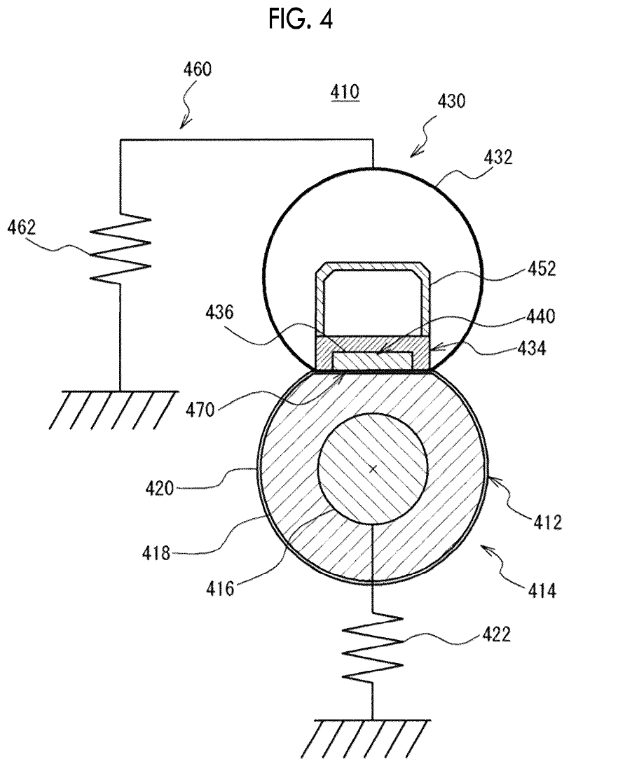

The third exemplary embodiment of the fixing device will be described with reference to FIG. 4. FIG. 4 is a schematic view showing a configuration of an example (that is, a fixing device 410) of the fixing device according to the third exemplary embodiment.

As shown in FIG. 4, the fixing device 410 has a pressure portion 414 and a heating portion 430 facing the pressure portion 414.

The pressure portion 414 includes a cylindrical roll member 412 (an example of the rotating body), is provided to face the heating portion 430, and is pressed against an outer surface of a heating belt 432 of the heating portion 430 and rotates by a drive device (not shown).

In the pressure portion 414, the roll member 412 is a so-called soft roll having a shaft portion 416 that consists of, for example, a metal material such as iron, stainless steel, and aluminum, an elastic layer 418 that covers the shaft portion 416, and a release layer 420 that coats or is applied to the elastic layer 418. The release layer 420 is formed of an insulating material having excellent release properties, such as PFA.

In the pressure portion 414, the roll member 412 is grounded, and the pressure portion 414 is grounded from the shaft portion 416 of the roll member 412 with a pressurizing portion-side resistor 422 interposed therebetween. By grounding the pressure portion 414 through the pressurizing portion-side resistor 422 in this way, the current leakage (leakage current) from the electrode of a planar heating element 440 of the heating portion 430 is suppressed.

In the pressure portion 414, the roll member 412 is pressed on the heating portion 430 by a pressing member (not shown) made of an elastic substance such as a coil spring. For example, one end of the pressing member is mounted on the shaft portion 416, and the other end is mounted on a body of an image forming apparatus.

The heating portion 430 has the heating belt 432 (an example of the fixing member) and has, on the inside of the heating belt 432, the planar heating element 440 that is a heating member heating the heating belt 432 from the inner peripheral surface side, a holding member 434 that holds the planar heating element 440, and a frame member 452 that supports the holding member 434. The holding member 434 is supported by the frame member 452, and has a structure that can withstand the pressure from the pressure portion 414.

A unit consisting of the planar heating element 440, the holding member 434, and the frame member 452 corresponds to an example of the pressing member.

In the heating portion 430, the heating belt 432 is supported at both ends of the heating belt 432 in the longitudinal direction. For example, a circular support member (not shown) is provided, and a heating member gear (not shown) that rotates the heating belt 432 is provided on the support member. One side of the heating member gear is connected to a drive device (not shown) such as a motor in the body of the image forming apparatus. The heating belt 432 is rotated.

In the heating portion 430, the planar heating element 440 as the heating member is, for example, in the form of a long plate-shaped element extending in the longitudinal direction of the heating portion 430. The planar heating element 440 has an electrically insulating substrate, an insulating layer formed of a polyimide-based heat-resistant resin, a pair of electrodes for power supply, and a resistive heating portion made, for example, of stainless steel that generates heat by being supplied with power from the electrodes. The electrodes and the resistive heating portion are connected by a power supply portion, and the electrodes, the power supply portion, and the resistive heating portion are embedded in an insulating layer. The electrodes of the planar heating element 440 are grounded with the heating portion-side resistor 462 interposed therebetween.

In the heating portion 430, the holding member 434 is formed of, for example, a resin material such as liquid crystal polymer (LCP) having high heat resistance, and on a side of the heating portion 430 facing the pressure portion 414, a groove portion 436 for holding the planar heating element 440 is formed along the longitudinal direction.

The holding member 434 is configured to form a pressing region 470 in a case where the holding member 434 is pressed on the pressure portion 414 in a state in which the planar heating element 440 is held in the groove portion 436.

In the heating portion 430, the frame member 452 is formed of, for example, a metal material, and the frame member 452 is configured to support the holding member 434, to be fixed to a support member (not shown) through both ends of the frame member 452, and enable the holding member 434 to withstand the pressure from the pressure portion 414. The heating portion 430 may be provided with a thermistor or the like for temperature detection.

In the fixing device 410 described above, in a state in which the heating belt 432 is sandwiched between the roll member 412 of the pressure portion 414 and the unit consisting of the planar heating element 440, the holding member 434, and the frame member 452 of the heating portion 430, the pressing region 470 is formed, and a recording medium holding an unfixed toner image is passed through the pressing region 470 such that the unfixed toner image is fixed by the application of heat and pressure.

### Image Forming Apparatus

Next, the image forming apparatus according to the present exemplary embodiment will be described.

The image forming apparatus according to the present exemplary embodiment includes an image holder, a charging device that charges a surface of the image holder, a latent image forming device that forms a latent image on the charged surface of the image holder, a developing device that develops the latent image by a toner to form a toner image, a transfer device that transfers the toner image to a recording medium, and a fixing device that fixes the toner image to the recording medium.

As the fixing device, the fixing device according to the present exemplary embodiment is applied.

In the image forming apparatus according to the present exemplary embodiment, the fixing device may be made into a cartridge such that the fixing device is detachable from an image forming apparatus. That is, the image forming apparatus according to the present exemplary embodiment may include the fixing device according to the present exemplary embodiment, as a device configuring a process cartridge.

Hereinafter, the image forming apparatus according to the present exemplary embodiment will be described with reference to a drawing.

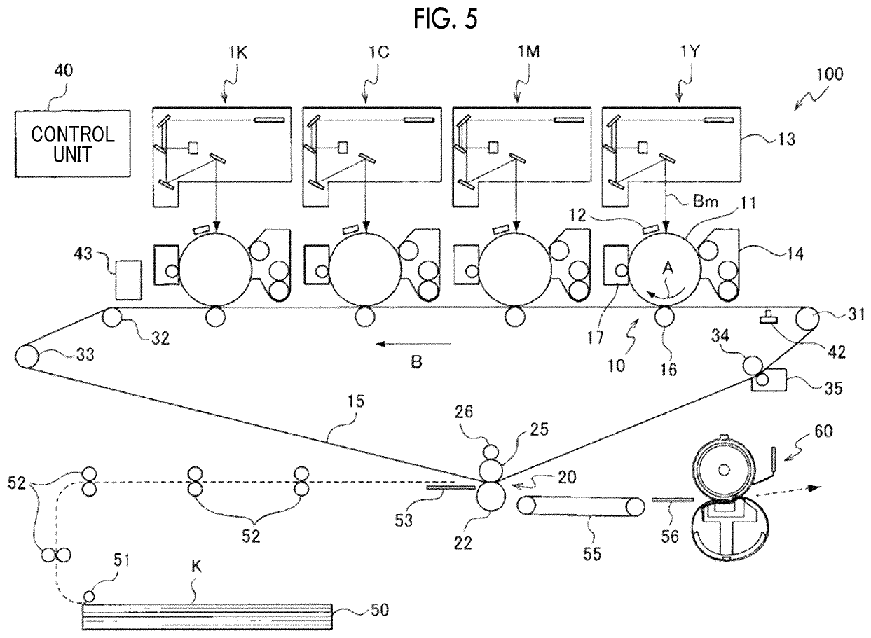

FIG. 5 is a view schematically showing a configuration of an example of the image forming apparatus according to the present exemplary embodiment.

As shown in FIG. 5, an image forming apparatus 100 according to the present exemplary embodiment is, for example, an intermediate transfer-type image forming apparatus that is generally called a tandem type, and includes a plurality of image forming units 1Y, 1M, 1C, and 1K in which a toner image of each color component is formed by an electrophotographic method, a primary transfer unit 10 that performs sequential transfer (primary transfer) of the toner image of each color component formed by each of the image forming units 1Y, 1M, 1C, and 1K to an intermediate transfer belt 15, a secondary transfer unit 20 that performs batch transfer (secondary transfer) of the overlapped toner images transferred to the intermediate transfer belt 15 to paper K as a recording medium, and a fixing device 60 that fixes the images transferred by the secondary transfer on the paper K. In addition, the image forming apparatus 100 includes a control unit 40 that controls the operation of each device (each unit).

The fixing device 60 is the first exemplary embodiment of the fixing device described above. The image forming apparatus 100 may be configured to include the second exemplary embodiment of the fixing device described above.

Each of the image forming units 1Y, 1M, 1C, and 1K of the image forming apparatus 100 includes a photoreceptor 11 that rotates in a direction of an arrow A, as an example of an image holder that holds a toner image formed on the surface.

As an example of the charging unit, a charger 12 for charging the photoreceptor 11 is provided around the photoreceptor 11, and as an example of the latent image forming unit, a laser exposure device 13 that draws an electrostatic latent image on the photoreceptor 11 is provided (in the figure, an exposure beam is represented by a reference numeral Bm).

Around the photoreceptor 11, as an example of a developing unit, there are provided a developing machine 14 that accommodates toners of each color component and makes the electrostatic latent image on the photoreceptor 11 into a visible image by using the toners and a primary transfer roll 16 that transfers toner images of each color component formed on the photoreceptor 11 to the intermediate transfer belt 15 by the primary transfer unit 10.

Furthermore, around the photoreceptor 11, there are provided a photoreceptor cleaner 17 that removes the residual toner on the photoreceptor 11 and devices for electrophotography, such as the charger 12, the laser exposure device 13, the developing machine 14, the primary transfer roll 16, and the photoreceptor cleaner 17, that are arranged in sequence along the rotation direction of the photoreceptor 11. These image forming units 1Y, 1M, 1C, and 1K are substantially linearly arranged in order of yellow (Y), magenta (M), cyan (C), and black (K) from the upstream side of the intermediate transfer belt 15.

The intermediate transfer belt 15 that is an intermediate transfer body is configured with a film-shaped pressurizing belt including a base layer that is a resin such as polyimide and polyamide, and containing an appropriate amount of an antistatic agent such as carbon black. The intermediate transfer belt 15 is configured to have a volume resistivity of 10⁶ Ωcm or more and 10¹⁴ Ωcm or less, and has a thickness of, for example, approximately 0.1 mm.

By various rolls, the intermediate transfer belt 15 is driven to circulate (rotate) in the B direction shown in FIG. 5 at a speed fit for the purpose. The image forming apparatus 100 has, as the various rolls, a driving roll 31 that is driven by a motor (not shown) excellent in maintaining a constant speed and rotates the intermediate transfer belt 15, a support roll 32 that supports the intermediate transfer belt 15 substantially linearly extending along the arrangement direction of each photoreceptor 11, a tension applying roll 33 that applies tension to the intermediate transfer belt 15 and functions as a correcting roll preventing meandering of the intermediate transfer belt 15, a back roll 25 that is provided in the secondary transfer unit 20, and a cleaning back roll 34 that is provided in a cleaning portion scrapping off the residual toner on the intermediate transfer belt 15.

The primary transfer unit 10 is configured with the primary transfer roll 16 that is disposed to face the photoreceptor 11 across the intermediate transfer belt 15. The primary transfer roll 16 is configured with a core and a sponge layer as an elastic layer, fixed around the core. The core is a cylindrical rod constituted of a metal such as iron and SUS. The sponge layer is a sponge-like cylindrical roll that is formed of blended rubber of NBR, SBR, and EPDM mixed with a conductive material such as carbon black, and has a volume resistivity of 10^{7.5} Ωcm or more and 10^{8.5} Ωcm or less.

The primary transfer roll 16 is disposed to be pressed against the photoreceptor 11 with the intermediate transfer belt 15 therebetween, and a voltage with a polarity (primary transfer bias) opposite to the charging polarity (negative polarity; the same applies hereafter) of the toner is applied to the primary transfer roll 16. As a result, the toner image on each photoreceptor 11 is sequentially electrostatically sucked onto the intermediate transfer belt 15, which leads to the formation of overlapped toner images on the intermediate transfer belt 15.

The secondary transfer unit 20 is configured to include the back roll 25 and a secondary transfer roll 22 that is disposed on a toner image-holding surface side of the intermediate transfer belt 15.

A surface of the back roll 25 is configured with a tube of blended rubber of EPDM and NBR in which carbon is dispersed, and the inside of the back roll 25 is configured with EPDM rubber. The back roll 25 is formed such that a surface resistivity thereof is 10⁷ Ω/□ or more and 10¹⁰Ω/□ or less, and a hardness of the back roll 25 is set to, for example, 70° (ASKER C: manufactured by KOBUNSHI KEIKI CO., LTD.; the same applies hereinafter). The back roll 25 is disposed on the back surface side of the intermediate transfer belt 15 to configure a counter electrode of the secondary transfer roll 22, and a power supply roll 26 made of a metal to which secondary transfer bias is stably applied is disposed to come into contact with the back roll 25.

The secondary transfer roll 22 is configured with a core and a sponge layer as an elastic layer, fixed around the core. The core is a cylindrical rod constituted of a metal such as iron and SUS. The sponge layer is a sponge-like cylindrical roll that is formed of blended rubber of NBR, SBR, and EPDM mixed with a conductive material such as carbon black, and has a volume resistivity of 10^{7.5} Ωcm or more and 10^{8.5} Ωcm or less.

The secondary transfer roll 22 is disposed to be pressed on the back roll 25 across the intermediate transfer belt 15, and the secondary transfer roll 22 is grounded such that the secondary transfer bias is formed between the secondary transfer roll 22 and the back roll 25, that induces secondary transfer of the toner image onto the paper K transported to the secondary transfer unit 20.

On the downstream side of the secondary transfer unit 20 of the intermediate transfer belt 15, an intermediate transfer belt cleaner 35 that removes the residual toner or paper powder on the intermediate transfer belt 15 remaining after the secondary transfer and cleans the surface of the intermediate transfer belt 15 is provided to be separable from the intermediate transfer belt 15.

The intermediate transfer belt 15, the primary transfer unit 10 (primary transfer roll 16), and the secondary transfer unit 20 (secondary transfer roll 22) correspond to an example of the transfer unit.

On the other hand, on the upstream side of the yellow image forming unit 1Y, a reference sensor (home position sensor) 42 is disposed that generates a reference signal to be a reference for taking the image forming timing in each of the image forming units 1Y, 1M, 1C, and 1K. The reference sensor 42 recognizes a mark provided on the back side of the intermediate transfer belt 15 and generates a reference signal, and each of the image forming units 1Y, 1M, 1C, and 1K is configured such that these units start to form images according to the instruction from the control unit 40 based on the recognition of the reference signal.

In addition, an image density sensor 43 used to adjust image quality is provided on the downstream side of the black image forming unit 1K.

The image forming apparatus according to the present exemplary embodiment includes, as a transport unit for transporting the paper K, a paper storage portion 50 that stores the paper K, a paper feeding roll 51 that takes out and transports the paper K stacked in the paper storage portion 50 at a predetermined timing, a transport roll 52 that transports the paper K transported by the paper feeding roll 51, a transport guide 53 that sends the paper K transported by the transport roll 52 to the secondary transfer unit 20, a transport belt 55 that transports the paper K transported after going through secondary transfer by the secondary transfer roll 22 to the fixing device 60, and a fixing inlet guide 56 that guides the paper K to the fixing device 60.

Next, basic image forming process of the image forming apparatus according to the present exemplary embodiment will be described.

In the image forming apparatus according to the present exemplary embodiment, image data output from an image reading device (not shown), a personal computer (PC) (not shown), or the like is subjected to image processing by an image processing device (not shown), and then the image forming units 1Y, 1M, 1C, and 1K perform the image forming operation.

In the image processing device, various types of image processing, such as shading correction, misregistration correction, brightness/color space conversion, gamma correction, frame removal or color editing, and movement editing, are performed on input image data. Image data on which the image processing is performed are converted into coloring material gradation data of four colors, that is, Y, M, C, and K, and are output to the laser exposure device 13.

In the laser exposure device 13, according to the input color material gradation data, for example, the photoreceptor 11 of each of the image forming units 1Y, 1M, 1C, and 1K is irradiated with an exposure beam Bm emitted from a semiconductor laser. The surface of each of the photoreceptors 11 of the image forming units 1Y, 1M, 1C, and 1K is charged by the charger 12, and is then scanned and exposed by the laser exposure device 13, so that the electrostatic latent image is formed. By each of the image forming units 1Y, 1M, 1C, and 1K, the formed electrostatic latent image is developed as a toner image of each of the colors Y, M, C, and K.

The toner image formed on each of the photoreceptors 11 of the image forming units 1Y, 1M, 1C, and 1K is transferred onto the intermediate transfer belt 15 at the primary transfer unit 10 where each photoreceptor 11 and the intermediate transfer belt 15 are in contact with each other. More specifically, in the primary transfer unit 10, by the primary transfer roll 16, a voltage (primary transfer bias) with a polarity opposite to the charging polarity (negative polarity) of the toner is applied to the base material of the intermediate transfer belt 15, and the toner images are sequentially overlapped on the surface of the intermediate transfer belt 15 and subjected to primary transfer.

After the primary transfer by which the toner images are sequentially transferred to the surface of the intermediate transfer belt 15, the intermediate transfer belt 15 moves, and the toner images are transported to the secondary transfer unit 20. In a case where the toner images are transported to the secondary transfer unit 20, in the transport unit, the paper feeding roll 51 rotates in accordance with the timing at which the toner images are transported to the secondary transfer unit 20, and the paper K having the target size is fed from the paper storage portion 50. The paper K fed from the paper feeding roll 51 is transported by the transport roll 52, passes through the transport guide 53, and reaches the secondary transfer unit 20. Before reaching the secondary transfer unit 20, the paper K is temporarily stopped, and a positioning roll (not shown) rotates according to the movement timing of the intermediate transfer belt 15 holding the toner image, so that the position of the paper K is aligned with the position of the toner image.

In the secondary transfer unit 20, through the intermediate transfer belt 15, the secondary transfer roll 22 is pressed on the back roll 25. At this time, the paper K transported at the right timing is interposed between the intermediate transfer belt 15 and the secondary transfer roll 22. At this time, in a case where a voltage (secondary transfer bias) with the same polarity as the charging polarity (negative polarity) of the toner is applied from the power supply roll 26, a transfer electric field is formed between the secondary transfer roll 22 and the back roll 25. In the secondary transfer unit 20 pressed by the secondary transfer roll 22 and the back roll 25, the unfixed toner images held on the intermediate transfer belt 15 are electrostatically transferred onto the paper K in a batch.

Thereafter, the paper K to which the toner images are electrostatically transferred is transported in a state of being peeled off from the intermediate transfer belt 15 by the secondary transfer roll 22, and is transported to the transport belt 55 provided on the downstream side of the secondary transfer roll 22 in the paper transport direction. The transport belt 55 transports the paper K to the fixing device 60 according to the optimum transport speed in the fixing device 60. The unfixed toner images on the paper K transported to the fixing device 60 are fixed on the paper K by being subjected to a fixing treatment by heat and pressure by the fixing device 60. The paper K on which the fixed image is formed is transported to an ejected paper-storing portion (not shown) provided in a discharge portion of the image forming apparatus.

Meanwhile, after the transfer to the paper K is finished, the residual toner remaining on the intermediate transfer belt 15 is transported to the cleaning portion as the intermediate transfer belt 15 rotates, and is removed from the intermediate transfer belt 15 by the cleaning back roll 34 and the intermediate transfer belt cleaner 35.

Although the present exemplary embodiment has been described, the present exemplary embodiment is not limited to the above-described exemplary embodiments, and various modifications, changes, and ameliorations may be added thereto.

### Examples

Hereinafter, the present exemplary embodiment will be described in more detail by Examples, but the present exemplary embodiment is not limited to Examples. In the following description, unless otherwise specified, “part” and “%” are based on mass.

### Preparation of Electrostatic Image Developer

### Preparation of Dispersion of Amorphous Polyester Resin Particles

### Preparation of Dispersion (1) of Amorphous Polyester Resin Particles

Terephthalic acid: 30 parts by mole
Fumaric acid: 70 parts by mole
Ethylene oxide adduct of bisphenol A: 5 parts by mole
Propylene oxide adduct of bisphenol A: 95 parts by mole

The above-described materials are charged into a flask with an inner capacity of 5 liter, equipped with a stirrer, a nitrogen introduction tube, a temperature sensor, and a rectifying column, the temperature is raised to 210° C. over 1 hour, and titanium tetraethoxide is added thereto in an amount of 1 part by mass with respect to 100 parts by mass of the above-described materials. While the generated water is distilled off, the temperature is raised to 230° C. over 0.5 hours, a dehydration condensation reaction is continued for 1 hour at the temperature, and then the reaction product is cooled. In this manner, an amorphous polyester resin (1) having a weight-average molecular weight of 18,500, an acid value of 14 mgKOH/g, and a glass transition temperature of 59° C. is obtained.

40 parts by mass of ethyl acetate and 25 parts by mass of 2-butanol are charged into a container equipped with a temperature control unit and a nitrogen purge unit, thereby preparing a mixed solvent. Thereafter, 100 parts by mass of the amorphous polyester resin (1) is slowly added to and dissolved in the solvent, a 10% by mass ammonia aqueous solution (in an amount equivalent to 3 times the acid value of the resin in terms of molar ratio) is added thereto, and the mixed solution is stirred for 30 minutes.

Next, the container is cleaned out by dry nitrogen purging, and in a state where the mixed solution is being stirred at a temperature kept at 40° C., 400 parts by mass of deionized water is added dropwise thereto at a rate of 2 parts by mass/min such that the mixed solution is emulsified. After the dropwise addition is completed, the temperature of the emulsion is returned to room temperature (20° C. to 25° C.), and bubbling is carried out under stirring for 48 hours by using dry nitrogen, thereby obtaining a resin particle dispersion in which the concentration of ethyl acetate and 2-butanol is reduced to 1,000 ppm or less (mass basis) and the resin particles having a volume average particle diameter of 200 nm is dispersed. Deionized water is added to the resin particle dispersion to adjust the solid content to 20% by mass, thereby obtaining a dispersion (1) of amorphous polyester resin particles.

### Preparation of Dispersion of Crystalline Polyester Resin Particles

### Preparation of Dispersion (1) of Crystalline Polyester Resin Particles

Dodecanedioic acid: 50 parts by mole
1,6-Hexanediol: 50 parts by mole

The above-described materials are charged into a reaction vessel equipped with a stirrer, a nitrogen introduction tube, a temperature sensor, and a rectifying column, the temperature is raised to 160° C. over 1 hour, and dibutyltin oxide is added to the mixture in an amount of 0.8 parts by mass with respect to 100 parts by mass of the above-described materials. While the generated water is distilled off, the temperature is raised to 180° C. over 6 hours, and the mixture is stirred for 5 hours in a state of being kept at 180° C. and refluxed such that the reaction proceeds. Next, the temperature is slowly raised to 230° C. under reduced pressure (3 kPa), and the reaction solution is stirred for 2 hours in a state of being kept at 230° C. Thereafter, the reactant is cooled. After the cooling, solid-liquid separation is performed, and the solids are dried, thereby obtaining a crystalline polyester resin (1). A weight-average molecular weight of the crystalline polyester resin (1) is 29,000.
Crystalline polyester resin (1): 100 parts by mass
Methyl ethyl ketone: 70 parts by mass
Isopropanol: 12 parts by mass
10% ammonia aqueous solution: 3 parts by mass

The above-described materials are put in a jacketed reaction tank equipped with a condenser, a thermometer, a water dripping device, and an anchor blade, and in a state in which the reaction tank is retained at a liquid temperature of 80° C. in a water-circulation type thermostatic bath, the resin is dissolved while stirring and mixing the mixture at 100 rpm. Next, the water-circulation type thermostatic bath is set to 60° C., and a total of 300 parts by mass of deionized water retained at 60° C. is added dropwise to the reaction tank at a rate of 3 parts by mass/min to cause phase inversion, thereby obtaining an emulsion. The obtained emulsion is added to an eggplant flask, and the eggplant flask is set through a trap ball in an evaporator equipped with a vacuum control unit. While being rotated, the eggplant flask is heated in a hot water bath at 60° C., the pressure is reduced to 7 kPa with care to sudden boiling to remove the solvent, and then returned to normal pressure, and the eggplant flask is water-cooled to obtain a dispersion. Deionized water is added to the dispersion, thereby obtaining a crystalline polyester resin particle dispersion (1) having a solid content of 20% by mass. A volume average particle diameter of the resin particles in the crystalline polyester resin particle dispersion (1) is 160 nm.

### Preparation of Colorant Particle Dispersion

### Preparation of Colorant Particle Dispersion (Black Pigment Dispersion)

Carbon black (manufactured by Cabot Corporation, Regal 330): 250 parts
Anionic surfactant (NEOGEN SC, manufactured by Daiichi Kogyo Seiyaku Co., Ltd.): 33 parts (60% of active ingredient, 8% with respect to colorant)
Deionized water: 750 parts

280 parts of deionized water and 33 parts of anionic surfactant are placed in a stainless steel container having a size such that the height of the liquid surface becomes approximately ⅓ of the height of the container in a case where all the above components are put therein. After the surfactant is sufficiently dissolved, all the solid solution pigments are added, and the mixture is stirred using a stirrer until the non-wet pigment disappears, and sufficiently defoamed. After defoaming, the remaining deionized water is added, and the mixture is dispersed at 5,000 rpm for 10 minutes using a homogenizer (ULTRA-TURRAX T50 manufactured by IKA), and then defoamed by stirring with a stirrer for 1 day and night. After defoaming, the mixture is dispersed again at 6,000 rpm for 10 minutes using the homogenizer, and then defoamed by stirring with a stirrer for 1 day and night. Subsequently, the dispersion is dispersed at a pressure of 240 MPa using a high-pressure impact disperser Ultimizer (HJP30006, manufactured by SUGINO MACHINE LIMITED CO., LTD.). Dispersion is carried out corresponding to 25 passes in terms of the total charge amount and the processing capacity of the apparatus. The obtained dispersion is left to stand for 72 hours to remove a precipitate, and deionized water is added to adjust the solid content concentration to 15%, thereby obtaining a colorant particle dispersion. A volume average particle diameter D50 of the particles in the colorant particle dispersion is 135 nm.

### Preparation of Release Agent Particle Dispersion

Synthetic wax (manufactured by NIPPON SEIRO CO., LTD., FNP-0090): 50 parts
Anionic surfactant (manufactured by Tayca Corporation, TaycaPower): 1 part
Deionized water: 200 parts

The above-described materials are mixed together, heated to 130° C., and dispersed using a homogenizer (manufactured by IKA, ULTRA-TURRAX T50). Thereafter, using Manton-Gaulin high-pressure homogenizer (manufactured by Gaulin), dispersion treatment is performed, thereby obtaining a release agent particle dispersion (solid content: 20% by mass) in which release agent particles are dispersed. A volume average particle diameter of the release agent particles is 214 nm.

### Preparation of Toner 1

Dispersion (1) of amorphous polyester resin particles: 553 parts
Dispersion (1) of crystalline polyester resin particles: 160 parts
Colorant particle dispersion: 117 parts
Release agent particle dispersion: 100 parts
Deionized water: 500 parts
Anionic surfactant (Dowfax2A1 manufactured by The Dow Chemical Company): 2.9 parts

The above-described components are charged into a 3 liter reaction container equipped with a thermometer, a pH meter, and a stirrer, and a pH of the components is adjusted to 4.5 by adding 2.0% nitric acid at a temperature of 25° C. Next, while dispersing at 5,000 rpm using a homogenizer (manufactured by IKA Japan: ULTRA-TURRAX T50), 123 parts of the prepared 1% aluminum sulfate aqueous solution is added and dispersed for 6 minutes.

Thereafter, a stirrer and a mantle heater are installed in the reaction container, and while the rotation speed of the stirrer is adjusted such that the slurry is sufficiently stirred, the solution is heated at a temperature rising rate of 0.2° C./min up to a temperature of 40° C. and at a temperature rising rate of 0.05° C./min after exceeding 40° C., and the particle diameter is measured every 10 minutes with Multisizer 4e (aperture size: 50 μm, manufactured by Beckman Coulter Inc.). The temperature is held until the volume average particle diameter reaches 4.2 μm, and 350 parts of the dispersion (1) of amorphous polyester resin particles is charged thereto over 5 minutes. After holding for 30 minutes, the pH is adjusted to 9.0 using a 4% sodium hydroxide aqueous solution. Thereafter, the temperature is raised to 85° C. at a temperature rising rate of 1° C./min while adjusting the pH to 9.0 at every 5° C. in the same manner. As a result of observing a shape and surface properties of the particles with an optical microscope and a scanning electron microscope (FE-SEM), the coalescence of the particles is confirmed after 5.0 hours. Therefore, the container is cooled to 30° C. for 5 minutes with cooling water.

The cooled slurry is allowed to pass through a nylon mesh having a mesh opening of 15 μm to remove coarse powder, and the toner slurry that has passed through the mesh is vacuum-filtered with an aspirator. The toner remaining on the filter paper is finely crushed by hand, added to deionized water in an amount of 10 times the toner at a temperature of 30° C., and the solution is mixed by being stirred for 30 minutes. Subsequently, the solution is vacuum-filtered with an aspirator, the toner remaining on the filter paper is finely crushed by hand and added to deionized water in an amount of 10 times the toner at a temperature of 30° C., and the solution is mixed by being stirred for 30 minutes and vacuum-filtered with an aspirator again, and the electrical conductivity of the filtrate is measured. The operation is repeated until the electrical conductivity of the filtrate becomes 10 μS/cm or less, and the toner is washed. The washed toner is finely crushed with a wet dry granulator (Comil), and vacuum-dried in an oven at 35° C. for 36 hours, thereby obtaining toner particles. A volume average particle diameter D50v of the obtained toner is 4.70 μm, and the number proportion of the toner particles having a particle diameter of 4 μm or less is 40%.

Thereafter, 3.3 parts of silica particles are added as an external additive to 100 parts of the toner particles. Next, the mixture is mixed at a peripheral speed of 30 m/s for 3 minutes using a Henschel mixer. Thereafter, the mixture is sieved using a vibration sieve having an opening of 45 μm, thereby obtaining a toner 1.

### Preparation of Toner 2

A toner 2 is obtained in the same manner as in the preparation of the toner 1, except that, in the preparation of the toner 1, the “temperature is held until the volume average particle diameter reaches 4.2 μm” is changed to “temperature is held until the volume average particle diameter reaches 4.7 μm”. A volume average particle diameter D50v of the obtained toner is 5.27 μm, and the number proportion of the toner particles having a particle diameter of 4 μm or less is 25%.

### Preparation of Toner 3

A toner 3 is obtained in the same manner as in the preparation of the toner 1, except that, in the preparation of the toner 1, the “temperature is held until the volume average particle diameter reaches 4.2 μm” is changed to “temperature is held until the volume average particle diameter reaches 5.0 μm”. A volume average particle diameter D50v of the obtained toner is 5.56 μm, and the number proportion of the toner particles having a particle diameter of 4 μm or less is 15%.

### Preparation of Toner 4

A black toner cartridge NPG-71 for a multifunction device iRA-C5560III manufactured by Canon Inc. is disassembled to take out a toner that is used as a toner 4. A volume average particle diameter D50v of the toner is 6.80 μm, and the number proportion of the toner particles having a particle diameter of 4 μm or less is 22%.

### Preparation of Toner 5

A black toner cartridge (model number 600477) for a multifunction device IMC6010 manufactured by RICOH COMPANY, LTD. is disassembled to take out a toner that is used as a toner 5. A volume average particle diameter D50v of the toner is 5.9 μm, and the number proportion of the toner particles having a particle diameter of 4 μm or less is 18%.

### Production of Carrier

500 parts of spherical magnetite particle powder having a volume average particle diameter of 0.18 μm is added to a Henschel mixer, and sufficiently stirred. Next, 5 parts of a titanate-based coupling agent is added thereto, the temperature is raised to 95° C., and the mixture is mixed and stirred for 30 minutes. As a result, spherical magnetite particles coated with a titanate-based coupling agent are obtained.

Subsequently, 6 parts of phenol, 10 parts of 30% formalin, 500 parts of the magnetite particles, 7 parts of 25% ammonia water, and 400 parts of water are added to a 1 L four-neck flask and mixed and stirred. Next, the temperature is raised to 90° C. in 60 minutes with stirring, the reaction is carried out at the same temperature for 180 minutes, the temperature is cooled to 30° C., 500 ml of water is added, the supernatant is then removed, and the precipitate is washed with water. The precipitate is dried at 180° C. under reduced pressure, and coarse powder is removed by a sieving net having an opening of 106 μm to obtain core material particles having an average particle diameter of 38 μm.

Next, 200 parts of toluene and 35 parts of a styrene-methyl methacrylate copolymer (component molar ratio of 10:90, weight-average molecular weight of 160,000) are stirred for 90 minutes with a stirrer to obtain a coated resin solution.

1,000 parts of core material particles and 70 parts of a coated resin solution are placed in a vacuum degassing type kneader coater (clearance between rotor and wall surface of 35 mm), and the mixture is stirred at 30 rpm for 30 minutes while maintaining 65° C. Next, the temperature is set to 88° C., the pressure is reduced, and toluene distillation, degassing, and drying are performed. Next, the resultant is passed a mesh having an opening of 75 μm. The shape factor SF2 of the carrier is 104.

### Production of Developer

8 parts of each of the toners (that is, any one of the toner 1 to the toner 5) and 100 parts of the carrier are mixed with a V blender to produce a developer.

### Production of Fixing Belt A1

SQ1: organopolysiloxane having a silsesquioxane structure (T type; manufactured by KONISHI CHEMICAL IND CO., LTD., “SR-13H”, organopolysiloxane having only the T unit represented by the formula: [R¹SiO_{3/2}]ₘ (in the formula, R¹=methyl group)): 30%
Dimethyl organopolysiloxane (D type) (manufactured by Shin-Etsu Chemical Co., Ltd., X34-1053-A/B, adjusted to elastic modulus shown in Table 1 by adjusting ratio of A agent and B agent): 60%
Heptane: 10%

The above-described components are mixed to obtain a coating material for a surface layer.

As an elastic layer, X34-3160-A/B manufactured by Shin-Etsu Chemical Co., Ltd. is applied onto and dried on a base material made of φ168 polyimide to form a film having an average film thickness of 500 μm. Next, as a surface layer, the above-described coating material for a surface layer is applied onto and dried on the elastic layer to form a surface layer having an average film thickness of 25 μm, thereby obtaining a fixing belt A1.

### Production of Fixing Belts A2 to A5, B1, and B2

Fixing belts A2 to A5 and B1 and B2 are obtained in the same manner as in the fixing belt A1, except that, in the production of the fixing belt A1, the amounts of SQ1: organopolysiloxane (T type) having a silsesquioxane structure and the dimethyl organopolysiloxane (D type) used in the surface layer of the fixing belt are changed to the amounts shown in Table 1, and the average film thickness of the surface layer and the average film thickness of the elastic layer are changed to the values in Table 1.

### Production of Fixing Belt A6

A fixing belt is obtained in the same manner as in the fixing belt A1, except that, in the production of the fixing belt A1, the SQ1: organopolysiloxane (T type) having a silsesquioxane structure used in the surface layer of the fixing belt is changed to the following SQ2.
SQ2: organopolysiloxane having a silsesquioxane structure (T type; manufactured by KONISHI CHEMICAL IND CO., LTD., “SR-23”, organopolysiloxane having only the T unit represented by the formula: [R¹SiO_{3/2}]ₘ (in the formula, R¹=phenyl group))

For the obtained surface layers of the fixing belts A2 to A6 and B1 and B2, the “difference ΔH between the maximum value and the minimum value of the ultramicrohardness” and the “tensile elongation rate” are measured. The results are shown in Table 1.

### Evaluation

In each of Examples and Comparative Examples, the belt described in Tables 1 and 2 as the fixing belt is mounted on a modified machine of an image forming apparatus REVORIA Press PC1120 (manufactured by Fujifilm Business Innovation Corp.), and a developer containing the toner described in Tables 1 and 2 mounted to prepare an image forming apparatus. The following points are evaluated using the image forming apparatus.

### Thin Line Reproducibility

The text “Hibiki” is printed on J paper (manufactured by Fujifilm Business Innovation Corp.) at 3 points and 5 points, and readability is evaluated by visual observation.

### Evaluation Indexes

A: both 3 points and 5 points are clear and easily readable.
B: 3 points are slightly crushed but readable, and 5 points are clear and easily readable.
C: 3 points are some unreadable text, and 5 points are some crushed but readable.
D: 3 points are most of the text unreadable, and 5 points are partially or completely unreadable.

### Offset

A black solid image is formed on a mirror coat platinum 256 gsm paper (manufactured by Fujifilm Business Innovation Corp.), and the image is evaluated by visual observation. The evaluation standard is as follows.

### Evaluation Indexes

A: no offset defect is visually observed in the image.
B: one or two offset defects are visually recognized in the image.
C: three or more and five or less offset defects are visually recognized in the image.
D: six or more offset defects are visually recognized in the image.

### Embossed Paper Fixing Properties

The black colorant in the toners 1 to 5 is changed to colorants of R, G, and B, and the toners of four colors (KRGB) are prepared for each of the toners 1 to 5.

Using the image forming apparatus of each example, images in which each image density of 50% is superimposed with four-color toners on A4 paper are output at a paper feed speed of 250 mm/s, including roughness portions of the paper. Thereafter, the fixed image is rubbed with a cotton swab, and a fixing degree is evaluated according to the following standard. As the A4 paper, embossed paper (manufactured by Tokai Special Paper Co., Ltd., REZAKKU 66, 151 gsm) having a large surface roughness is used.

### Evaluation Indexes

A: image is fixed to the paper roughness portion.
B: image is fixed to the paper roughness portion, but fixing failure is observed at one location when rubbed.
C: image is fixed to the paper roughness portion, but fixing failure is observed at two or more and four or less locations when rubbed.
D: image is not fixed to the paper roughness portion.

TABLE 1

| | Fixing belt | | | | | | | | | | | | |
|---|---|---|---|---|---|---|---|---|---|---|---|---|---|
| | | | | | | | | | | | Evaluation | | |
| | | Surface layer | | | | | | | Elastic | | (Image | | |
| | | | | | Film | Dif- | Tensile | | layer | | quality) | | Embossed |
| | | | T | D | thick- | fer- | elon- | Elastic | Film | | thin line | | paper |
| | | T type | type | type | ness | ence | gation | modulus | thickness | Developer | repro- | | fixing |
| | Type | material | ratio | ratio | μm | ΔH | rate | MPa | μm | Type | ducibility | Offset | properties |
| Example 1 | Belt | SQ1 | 33% | 67% | 25 | 20% | 75% | 24 | 500 | Toner 1 | A | A | A |
| | A1 | | | | | | | | | | | | |
| Example 2 | Belt | SQ1 | 10% | 90% | 25 | 45% | 80% | 20 | 500 | Toner 1 | B | B | A |
| | A2 | | | | | | | | | | | | |
| Example 3 | Belt | SQ1 | 90% | 10% | 25 | 23% | 25% | 98 | 500 | Toner 1 | A | A | B |
| | A3 | | | | | | | | | | | | |
| Example 4 | Belt | SQ1 | 33% | 67% | 50 | 33% | 42% | 30 | 500 | Toner 1 | A | A | B |
| | A4 | | | | | | | | | | | | |
| Example 5 | Belt | SQ1 | 33% | 67% | 25 | 33% | 45% | 25 | 250 | Toner 1 | A | A | B |
| | A5 | | | | | | | | | | | | |
| Example 6 | Belt | SQ2 | 33% | 67% | 25 | 38% | 73% | 30 | 500 | Toner 1 | B | B | A |
| | A6 | | | | | | | | | | | | |
| Comparative | Belt | SQ1 | 95% | 5% | 25 | 48% | 9% | 120 | 500 | Toner 1 | C | C | D |
| Example 1 | B1 | | | | | | | | | | | | |
| Comparative | Belt | SQ1 | 5% | 95% | 25 | 75% | 110% | 16 | 500 | Toner 1 | D | D | C |
| Example 2 | B2 | | | | | | | | | | | | |

The evaluation is performed using the fixing belts of Example 1 and Comparative Examples 1 and 2 (that is, the belts A1, B1, and B2) and using the developers (toners 1 to 5) having different number proportions of toner particles having a particle diameter of 4 μm or less (referred to as “Amount of fine powder” in Table 2) as the developers. The results are shown in Table 2.

TABLE 2

| | Fixing belt | | | | | | | | | | | | | |
|---|---|---|---|---|---|---|---|---|---|---|---|---|---|---|
| | | | | | | | | | Elastic | Developer | | Evaluation | | |
| | | Surface layer | | | | | | | layer | | Amount | (Image | | |
| | | | | | Film | Dif- | Tensile | | Film | | of fine | quality) | | Embossed |
| | | | T | D | thick- | fer- | elon- | Elastic | thick- | | powder | thin line | | paper |
| | | T type | type | type | ness | ence | gation | modulus | ness | | % by | repro- | Off- | fixing |
| | Type | material | ratio | ratio | μm | ΔH | rate | MPa | μm | Type | number | ducibility | set | properties |
| Example 11 | Belt A1 | SQ1 | 33% | 67% | 25 | 20% | 75% | 24 | 500 | Toner 1 | 40 | A | A | A |
| Example 12 | Belt A1 | SQ1 | 33% | 67% | 25 | 20% | 75% | 24 | 500 | Toner 2 | 25 | A | A | A |
| Example 13 | Belt A1 | SQ1 | 33% | 67% | 25 | 20% | 75% | 24 | 500 | Toner 3 | 15 | A | A | B |
| Example 14 | Belt A1 | SQ1 | 33% | 67% | 25 | 20% | 75% | 24 | 500 | Toner 4 | 22 | B | A | B |
| Example 15 | Belt A1 | SQ1 | 33% | 67% | 25 | 20% | 75% | 24 | 500 | Toner 5 | 18 | B | A | B |
| Comparative | Belt B1 | SQ1 | 95% | 5% | 25 | 58% | 9% | 120 | 500 | Toner 1 | 40 | C | D | D |
| Example 11 | | | | | | | | | | | | | | |
| Comparative | Belt B1 | SQ1 | 95% | 5% | 25 | 58% | 9% | 120 | 500 | Toner 2 | 25 | C | D | D |
| Example 12 | | | | | | | | | | | | | | |
| Comparative | Belt B1 | SQ1 | 95% | 5% | 25 | 58% | 9% | 120 | 500 | Toner 3 | 15 | D | D | D |
| Example 13 | | | | | | | | | | | | | | |
| Comparative | Belt B1 | SQ1 | 95% | 5% | 25 | 58% | 9% | 120 | 500 | Toner 4 | 22 | C | C | D |
| Example 14 | | | | | | | | | | | | | | |
| Comparative | Belt B1 | SQ1 | 95% | 5% | 25 | 58% | 9% | 120 | 500 | Toner 5 | 18 | D | D | D |
| Example 15 | | | | | | | | | | | | | | |
| Comparative | Belt B2 | SQ1 | 5% | 95% | 25 | 75% | 110% | 16 | 500 | Toner 1 | 40 | D | D | C |
| Example 21 | | | | | | | | | | | | | | |
| Comparative | Belt B2 | SQ1 | 5% | 95% | 25 | 75% | 110% | 16 | 500 | Toner 2 | 25 | D | D | C |
| Example 22 | | | | | | | | | | | | | | |
| Comparative | Belt B2 | SQ1 | 5% | 95% | 25 | 75% | 110% | 16 | 500 | Toner 3 | 15 | D | D | D |
| Example 23 | | | | | | | | | | | | | | |
| Comparative | Belt B2 | SQ1 | 5% | 95% | 25 | 75% | 110% | 16 | 500 | Toner 4 | 22 | D | D | D |
| Example 24 | | | | | | | | | | | | | | |
| Comparative | Belt B2 | SQ1 | 5% | 95% | 25 | 75% | 110% | 16 | 500 | Toner 5 | 18 | D | D | C |
| Example 25 | | | | | | | | | | | | | | |

From the results shown in Tables 1 and 2, it is found that Examples have more excellent fixing properties on the embossed paper than Comparative Examples.

Hereinafter, aspects of the present invention will be additionally described.

<<<1>>>

An image forming apparatus comprising:
an image holder;
a charging unit that charges a surface of the image holder;
an electrostatic image forming unit that forms an electrostatic image on the charged surface of the image holder;
a developing unit that accommodates an electrostatic image developer containing a toner in which a number proportion of toner particles having a particle diameter of 4 μm or less is 15% by number or more, and that develops the electrostatic image formed on the surface of the image holder into a toner image with the electrostatic image developer;
a transfer unit that transfers the toner image onto a recording medium; and
a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at arbitrary 50 points by an ultramicrohardness test specified in JIS Z2255 (2003), is 0% or more and 50% or less, and that fixes the toner image onto the recording medium by bringing the surface layer of the fixing member into contact with the toner image on the recording medium and heating and pressurizing the recording medium,

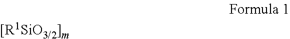

(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).
   <<<2>>>

The image forming apparatus according to <<<1>>>,
wherein the contained ratio (T type/D type) in the composition is 3/7 or more and 7/3 or less.
   <<<3>>>

The image forming apparatus according to <<<1>>> or <<<2>>>,
wherein, in the surface layer, the difference ΔH between the maximum value and the minimum value of the ultramicrohardness is 0% or more and 40% or less.
   <<<4>>>

The image forming apparatus according to any one of <<<1>>> to <<<3>>>,
wherein the surface layer has a tensile elongation rate of 50% or more.
   <<<5>>>

The image forming apparatus according to <<<4>>>,
wherein the tensile elongation rate of the surface layer is 70% or more.
   <<<6>>>

The image forming apparatus according to any one of <<<1>>> to <<<5>>>,
wherein the fixing member has an elastic layer and the surface layer on the elastic layer, and
an average film thickness of the surface layer is 30 μm or less, and an average film thickness of the elastic layer is 300 μm or more.
   <<<7>>>

The image forming apparatus according to <<<6>>>,
wherein the average film thickness of the surface layer is 10 μm or more and 50 μm or less, and the average film thickness of the elastic layer is 150 μm or more and 600 μm or less.
   <<<8>>>

The image forming apparatus according to any one of <<<1>>> to <<<7>>>,
wherein at least one of R¹'s is a methyl group or a phenyl group.
   <<<9>>>

The image forming apparatus according to <<<8>>>,
wherein at least one of R¹'s is a methyl group.
   <<<10>>>

An image forming method comprising:
charging a surface of an image holder;
forming an electrostatic image on the charged surface of the image holder;
developing the electrostatic image formed on the surface of the image holder into a toner image with an electrostatic image developer containing a toner in which a number proportion of toner particles having a particle diameter of 4 μm or less is 15% by number or more;
transferring the toner image formed on the surface of the image holder onto a surface of a recording medium; and
using a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at arbitrary 50 points by an ultramicrohardness test specified in JIS Z2255 (2003), is 0% or more and 50% or less, fixing the toner image onto the recording medium by bringing the surface layer of the fixing member into contact with the toner image on the recording medium and heating and pressurizing the recording medium,

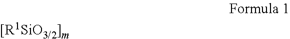

(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
an image holder;
a charging unit that charges a surface of the image holder;
an electrostatic image forming unit that forms an electrostatic image on the charged surface of the image holder;
a developing unit that accommodates an electrostatic image developer containing a toner in which a number proportion of toner particles having a particle diameter of 4 μm or less is 15% by number or more, and that develops the electrostatic image formed on the surface of the image holder into a toner image with the electrostatic image developer;
a transfer unit that transfers the toner image onto a recording medium; and
a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at arbitrary 50 points by an ultramicrohardness test specified in JIS Z2255 (2003), is 0% or more and 50% or less, and that fixes the toner image onto the recording medium by bringing the surface layer of the fixing member into contact with the toner image on the recording medium and heating and pressurizing the recording medium, 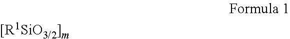
(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).

2. The image forming apparatus according to claim 1,
wherein the contained ratio (T type/D type) in the composition is 3/7 or more and 7/3 or less.

3. The image forming apparatus according to claim 1,
wherein, in the surface layer, the difference ΔH between the maximum value and the minimum value of the ultramicrohardness is 0% or more and 40% or less.

4. The image forming apparatus according to claim 1,
wherein the surface layer has a tensile elongation rate of 50% or more.

5. The image forming apparatus according to claim 4,
wherein the tensile elongation rate of the surface layer is 70% or more.

6. The image forming apparatus according to claim 1,
wherein the fixing member has an elastic layer and the surface layer on the elastic layer, and
an average film thickness of the surface layer is 30 μm or less, and an average film thickness of the elastic layer is 300 μm or more.

7. The image forming apparatus according to claim 6,
wherein the average film thickness of the surface layer is 10 μm or more and 50 μm or less, and the average film thickness of the elastic layer is 150 μm or more and 600 μm or less.

8. The image forming apparatus according to claim 1,
wherein at least one of R¹'s is a methyl group or a phenyl group.

9. The image forming apparatus according to claim 8,
wherein at least one of R¹'s is a methyl group.

10. An image forming method comprising:
charging a surface of an image holder;
forming an electrostatic image on the charged surface of the image holder;
developing the electrostatic image formed on the surface of the image holder into a toner image with an electrostatic image developer containing a toner in which a number proportion of toner particles having a particle diameter of 4 μm or less is 15% by number or more;
transferring the toner image formed on the surface of the image holder onto a surface of a recording medium; and
using a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at arbitrary 50 points by an ultramicrohardness test specified in JIS Z2255 (2003), is 0% or more and 50% or less, fixing the toner image onto the recording medium by bringing the surface layer of the fixing member into contact with the toner image on the recording medium and heating and pressurizing the recording medium, 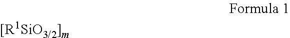
(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).

11. An image forming apparatus comprising:
an image holder;
a charging means for charging a surface of the image holder;
an electrostatic image forming means for forming an electrostatic image on the charged surface of the image holder;
a developing means for accommodating an electrostatic image developer containing a toner in which a number proportion of toner particles having a particle diameter of 4 μm or less is 15% by number or more, and for developing the electrostatic image formed on the surface of the image holder into a toner image with the electrostatic image developer;
a transfer means for transferring the toner image onto a recording medium; and
a fixing device that includes a fixing member having a surface layer that contains no fluorine atom and is a cured product of a composition containing an organopolysiloxane (T type) having a silsesquioxane structure represented by Formula 1 and dimethyl organopolysiloxane (D type), in which a contained ratio (T type/D type) of the organopolysiloxane (T type) to the dimethyl organopolysiloxane (D type) is 1/9 or more and 9/1 or less, and a difference ΔH between a maximum value and a minimum value of an ultramicrohardness of the surface layer, that is measured at arbitrary 50 points by an ultramicrohardness test specified in JIS Z2255 (2003), is 0% or more and 50% or less, and that fixes the toner image onto the recording medium by bringing the surface layer of the fixing member into contact with the toner image on the recording medium and heating and pressurizing the recording medium, 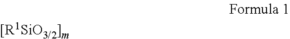
(in Formula 1, R¹'s each independently represent a hydrogen atom, an alkyl group, an alkenyl group, an alkynyl group, an aralkyl group, an aryl group, a group represented by —C(═O)—CR²₃, or a monovalent organic group having a reactive group,
a plurality of R¹'s may be the same or different from each other,
R² represents a hydrogen atom, a methyl group, or an ethyl group,
in a case of a plurality of R²'s, the plurality of R²'s may be the same or different from each other,
the monovalent organic group may be substituted with a halogen atom, a hydroxy group, an alkoxy group, an aryloxy group, an aralkyloxy group, or an oxy group,
the alkyl group, the alkenyl group, the alkynyl group, the aralkyl group, and the aryl group may have a substituent, and
m represents a positive integer).
